(19) United States
(12) Patent Application Publication
(10) Pub. No.: US 2017/0144408 A1
(43) Pub. Date: May 25, 2017

(54) CONDUCTIVE FILM, POLARIZING PLATE, AND DISPLAY DEVICE PROVIDED WITH TOUCH PANEL

(71) Applicant: FUJIFILM Corporation, Tokyo (JP)

(72) Inventor: Hiroaki SATA, Kanagawa (JP)

(73) Assignee: FUJIFILM Corporation, Tokyo (JP)

(21) Appl. No.: 15/406,183

(22) Filed: Jan. 13, 2017

Related U.S. Application Data
(63) Continuation of application No. PCT/JP2015/069661, filed on Jul. 8, 2015.

(30) Foreign Application Priority Data
Jul. 17, 2014 (JP) 2014-147167

(51) Int. Cl. B32B 5/16; B32B 27/30; B32B 27/32; H01B 5/14; B32B 27/14; G06F 3/044; G02B 5/30; B32B 23/20; B32B 23/12

(52) U.S. Cl. CPC B32B 5/16; B32B 23/20; B32B 27/308; B32B 27/325; B32B 23/12; B32B 27/14; G06F 3/044; G02B 5/3025; H01B 5/14; B32B 2255/04; B32B 2255/26; B32B 2264/108; B32B 2307/202; B32B 2307/42; B32B 2457/208

(57) ABSTRACT

An object of the present invention is to provide a conductive film which can he easily produced, has high light transmittance and has excellent flatness, and has a hard coat layer; and a polarizing plate and a display device provided with a touch panel which have a conductive film. The conductive film of the present invention includes a support which has an in-plane retardation Re (550) of 10 nm or less at a wavelength of 550 nm and has a retardation Rth (550) of −60 to 60 nm at a wavelength of 550 nm in a thickness direction; a conductive layer which is disposed on at least one surface of the support, includes fullerene functionalized carbon nanotubes, and has a thickness of less than 10 μm; and a hard coat layer which is disposed adjacent to the conductive layer.

### CROSS-REFERENCE TO RELATED APPLICATIONS

This application is a Continuation of PCI International. Application No. PCT/JP2015/069661 filed on Jul. 8, 2015, which claims priority under 35 U.S.C. §119(a) to Japanese Patent Application No. 2014-147167 filed on Jul. 14, 2014. The above application is hereby expressly incorporated by reference, in its entirety, into the present application.

### BACKGROUND OF THE INVENTION

1. Field of the invention

The present invention relates to a conductive film, a polarizing plate, and a display device provided with a touch panel.

2. Description of the Related Art

A conductive film having a conductive layer formed on a substrate has been widely used for transparent electrodes of various electronic devices such as solar cells, inorganic EL (electroluminescence) elements, and organic EL elements, electromagnetic wave shields of various display devices, touch panels, and transparent planar heating elements. In recent years, particularly, the proportion of mobile phones or portable game machines in which touch panels are mounted has increased and a demand for conductive films for touch panels has been rapidly expanding.

From the viewpoints of high transparency and the price, a polyethylene terephthalate (PET) film has been widely used as a support of a conductive film for a touch panel, and an indium tin oxide (ITO) layer formed by carrying out a dry process such as vacuum vapor deposition or sputtering has been widely used as a conductive layer (JP2012-164079A).

### SUMMARY OF THE INVENTION

In addition, from the viewpoint of improving visibility of a touch panel, there has been a recent demand for further improvement of transparency of various members used for a touch panel. However, PET films which are typically used do not satisfy the level of transparency required nowadays. Further, interference unevenness easily occurs and the display quality of a display device provided with a touch panel for which a PET film is used has not been sufficient.

As described above, since ITO which has been widely used as a transparent conductive material of a conductive film is produced by carrying out a dry process typically with associated high temperature conditions, heat resistance of a support in the conductive film becomes necessary. Further, evacuation is required during the dry process and there is a problem in that components, having a low molecular weight, contained in the conductive film or an additive added for the purpose of high functionality are volatilized to cause process contamination and surface failure. There are disadvantages that the machining speed is slow and the productivity is low. Therefore, development of other alternative materials has been desired.

Further, in order to improve the impact resistance or ease of handling of the conductive layer, a hard coat layer may be disposed on the surface of the conductive layer. A hard coat layer is typically farmed by curing a curable composition in many cases and thus curing contraction easily occurs during the formation of a hard coat layer.

Recently, from the viewpoint of reducing a thickness of a display device including a touch panel, the thickness of a member being used has become small. Consequently, there is also a problem in that wrinkles easily occur in the entire conductive film due to the above-described curing contraction and the flatness is impaired in a case where a hard coat layer is disposed on the top of a thin support.

The present invention has been made in consideration of the above-described circumstances, and an object of the present invention is to provide a conductive film which can be easily produced, has high light transmittance and has excellent flatness, and has a hard coat layer.

Further, another object of the present invention is to provide a polarizing plate and a display device provided with a touch panel which have the above-described conductive film.

The present inventors conducted intensive research on the problems of the related art and found that the above-described problems can be solved using a conductive layer that includes a support exhibiting predetermined optical characteristics and fullerene functionalized carbon nanotubes.

That is, the present inventors found that the above-described problems can be solved by the following configuration.

(1) A conductive film comprising: a support which has an in-plane retardation of 10 nm or less at a wavelength of 550 nm and has a retardation of −60 to 60 nm at a wavelength of 550 nm in a thickness direction; a conductive layer which is disposed on at least one surface of the support, includes fullerene functionalized carbon nanotubes, and has a thickness of less than 10 μm; and a hard coat layer which is disposed adjacent to the conductive layer.

(2) The conductive film according to (1), in which a sheet resistance value is in a range of 10 to 150 Ω/□.

(3) The conductive film according to (1) or (2), in which the thickness of the support is in a range of 10 to 80 μm.

(4) The conductive film according to any one of (1) to (3), in which the support includes at least one selected from the group consisting of a cellulose acylate resin, an acrylic resin, a methacrylic resin, and a cycloolefine resin.

(5) A polarizing plate comprising: the conductive film according to any one of (1) to (4); and a polarizer.

(6) The conductive film according to any one of (1) to (4), which is used for a touch panel.

(7) A display device provided with a touch panel comprising: the conductive film according to (6).

According to the present invention, it is possible to provide a conductive film which can be easily produced, has high light transmittance and has excellent flatness, and has a hard coat layer.

Further, according to the present invention, it is possible to provide a polarizing plate and a display device provided with a touch panel which have the above-described conductive film.

### BRIEF DESCRIPTION OF THE DRAWINGS

FIG. 1 is a sectional view schematically illustrating a display device provided with a touch panel according to a first embodiment of the present invention.

FIG. 2 is a plan view illustrating a conductive film.

FIG. 3 is a sectional view taken along the cutting line A-A of FIG. 2.

FIG. 4 is a sectional view schematically illustrating a display device provided, with a touch panel according to a second embodiment of the present invention.

FIG. 5 is a plan view of a conductive film.

FIG. 6 is a sectional view taken along the cutting line B-B of FIG. 5.

### DESCRIPTION OF THE PREFERRED EMBODIMENTS

Hereinafter, a conductive film, a polarizing plate, and a display device provided with a touch panel of the present invention will be described in detail.

In the present specification, the numerical ranges shown using “to” indicate ranges including the numerical values described before and after “to” as the lower limits and the upper limits. Moreover, the views of the present invention are schematic views and the relationships in thickness of each layer or positional relationships do not necessarily coincide with the actual ones.

Re (λ) and Rth (λ) each represent an in-plane retardation and a retardation in a thickness direction at a wavelength of λ. The Re (λ) is measured by allowing light having a wavelength of λ nm to be incident in a film normal direction in KOBRA 21ADH or WR. (manufactured by Oji Scientific Instruments). At the time of selecting the measurement wavelength of λ nm, measurement can be performed by manually replacing a wavelength selective filter or converting measured values using a program or the like. In a case where the film to be measured is represented by a monoaxial or biaxial index ellipsoid, the Rth (λ) is calculated by the following method. Further, this measurement method is partially used for measuring an average tilt angle of a liquid crystal compound and measuring an average tilt angle on the opposite side thereto.

The Rth (λ) is obtained by allowing light having a wavelength of λ nm to be incident from inclined directions from the normal direction with respect to the film normal direction to 50° on one side by a step of 10° using an in-plane slow axis (determined by KOBRA 21 ADH or WR) as an inclined axis (rotation axis) (in a case where the slow axis is not present, an arbitrary direction in the film plane is set as the rotation axis) to measure six points of the above-described Re (λ) in total and KOBRA 21ADH or WR is calculated based on the measured retardation values, the assumed value of the average refractive index, and the input film thickness. In a case of a film having a direction in which the retardation value at a tilt angle becomes zero using the in-plane slow axis from the normal direction as the rotation axis, the symbol of the retardation value at a tilt angle greater than the tilt angle is changed into negative, and then KOBRA 21ADH or WR is calculated. Further, retardation values from two arbitrary inclined directions are measured using the slow axis as the inclined axis (rotation axis) (in a case where the slow axis is not present, an arbitrary direction in the film plane is set as the rotation axis) and the Rth can be calculated using the following Equations (A) and (B) based on the measured values, the assumed value of the average refractive index, and the input film thickness.

$$Equation ( A )$$

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos ( {sin}^{- 1} ( \frac{sin ( - θ )}{nx} ) )}$$

Moreover, the Re (0) represents a retardation value in a direction inclined from the normal direction by an angle of θ. Further, nx in Equation (A) represents a refractive index in a slow axis direction in the plane, ny represents a refractive index in the plane in a direction perpendicular to nx, and nz represents a refractive index in a direction perpendicular to nz and ny. d represents the thickness of the measurement film.

Rth=((nx+ny)/2−nz)×d Equation (B)

In a case where the film to be measured cannot be represented by a uniaxial or biaxial index ellipsoid, that is, a so-called optic axis is not present, the Rth (λ) is calculated by the following method. The Rth (λ) is obtained by allowing light having a wavelength of λ nm to be incident from inclined directions from −50° to +50° with respect to the film normal direction by a step of 10° using an in-plane slow axis (determined by KOBRA 21ADH or WR) as an inclined axis (rotation axis) to measure 11 points of the above-described Re (λ) and KOBRA 21ADH or WR is calculated based on the measured retardation values, the assumed value of the average refractive index, and the input film thickness. Moreover, in the measurement described above, catalog values of Polymer Handbook (JOHN WILEY & SONS, INC) and various optical films can be used as the assumed value of the average refractive index. When the value of the average refractive index is not known, the value can be measured using an Abbe refractometer. Examples of the value of the average refractive index of a min optical film include: cellulose acylate (1.48), cycloolefine polymer (1.52), polycarbonate (1.59), polymethyl methacrylate (1.49), and polystyrene (1.59). nx, ny, and nz are calculated from KOBRA 21ADH or WR by inputting the assumed values and the film thicknesses of the average refractive index.

One feature point of the conductive film of the present invention is that a support exhibiting a predetermined optical characteristic is used. That is, in the present invention, the light transmittance is improved and interference unevenness that easily occurs in a PET film is resolved by means of using a support (low phase difference film) having a low in-plane retardation and a low retardation in the thickness direction.

Further, as described above, an ITO layer widely used as a conductive layer is typically produced by a dry process accompanied by high temperature conditions, but the above-described low phase difference film typically has inferior heat resistance and mechanical strength compared to a PET film and thus decomposition is unlikely to occur during the dry process. Therefore, it is difficult to apply the above-described low phase difference film.

Meanwhile, another feature point of the conductive film of the present invention is that a conductive layer containing fullerene functionalized carbon nanotubes is used. As described later in detail, fullerene functionalized carbon nanotubes includes one or plural fullerenes and/or fullerene-based molecules covalently bonded to carbon nanotubes. A fullerene functionalized carbon nanotube is a material that has mechanical flexibility derived from carbon nanotubes and exhibits excellent conductivity more than carbon nanotubes as a result of adding a fullerene functional group. In the conductive layer, a network structure is easily formed while fullerene functionalized carbon nanotubes are entangled with each other, and a fullerene functional group comes into contact with a fullerene functionalized carbon nanotube adjacent to the fullerene functional group to obtain a conductive layer exhibiting excellent conduction characteristics. Moreover, as described later, when a conductive layer containing fullerene functionalized carbon nanotubes is prepared, high temperature vacuum conditions are not required. Accordingly, compared to a case where an ITO film is prepared by a dry process, performance degradation of a support can be suppressed.

In the conductive film of the present invention, wrinkles or the like derived from a hard coat layer are unlikely to occur. The details of the reason are not clear, but are assumed as follows. First, as described above, since a network structure is formed while fullerene functionalized carbon nanotubes are entangled with each other in the conductive layer, the stress applied to the conductive layer is easily relaxed. Accordingly, it is assumed that the conductive layer disposed adjacent to a hard coat layer functions as a so-called stress relaxation layer and occurrence of wrinkles on the entire conductive film is suppressed.

[Conductive Film]

The conductive film of the present invention includes at least a support exhibiting predetermined optical characteristics; a conductive layer which is disposed on the support and, contains fullerene functionalized carbon nanotubes; and a hard coat layer disposed adjacent to the support.

Hereinafter, members (the support, the conductive layer, the hard coat layer, and the like) included in the conductive film will be described in detail.

<Support>

The support is a base supporting the conductive layer.

An in-plane retardation Re (550) of the support at a wavelength of 550 nm is 10 nm or less. From the viewpoint of more excellent optical characteristics of the conductive film, the in-plane retardation Re (550) thereof is preferably 7 nm or less and more preferably 5 nm or less. The lower limit thereof is not particularly limited, but is typically 0 nm.

A retardation Rth (550) of the support in the thickness direction at a wavelength of 550 nm is in a range of −60 to 60 nm. From the viewpoint of more excellent optical characteristics of the conductive film, the retardation Rib (550) is preferably in a range of −45 to 45 nm and more preferably in a range of −35 to 35 nm.

The thickness of the support is not particularly limited, but is preferably in a range of 10 to 80 μm and more preferably in a range of 10 to 60 μm, from the viewpoint of reducing the thickness of a display device.

In addition, the above-described thickness is an average value obtained by measuring the thicknesses of arbitrary 10 points of the support and arithmetically averaging the values.

The support is not particularly limited as long as the above-described optical characteristics are satisfied, and a known transparent support can be used. Examples of the material that forms a transparent support include a cellulose acylate resin represented by triacetyl cellulose, a cycloolefine resin (ZEONEX and ZEONOR manufactured by ZEON CORPORATION or ARTON manufactured by JSR Corporation), and a (meth) acrylic resin. Further, the “(meth)acryloyi resin” indicates an acrylic resin or a methacrylic resin.

As one preferred embodiment of the support, a cellulose ester film can be used.

(Cellulose Ester)

A cellulose ester film contains cellulose ester.

In the present invention, a cellulose ester film can be obtained, for example, by preparing a film using powdery, particulate, or pelletized cellulose ester.

The cellulose ester film may be formed of one cellulose ester or two or more kinds of cellulose esters.

Cellulose acylate is preferable as cellulose ester.

Cellulose acylate used in the present invention is not particularly limited. Examples of the cellulose of acylate raw materials include cotton linter and wood pulp (hardwood pulp and softwood pulp), and cellulose acylate obtained from any cellulose raw material can be used and a mixture of acylate raw materials can be used in some cases. These cellulose raw materials are specifically described in, for example, “Plastic Material Course (17) Cellulose-based Resin” written by Mausawa and Uda, Nikkan Kogyo Shimbun, Ltd. (published in 1970) and Journal of technical disclosure No. 2001-1745 (p. 7 and 8), and cellulose described herein can be used.

Cellulose acylate preferably used in the present invention will be briefly described. A glucose unit linked to β-1,4 constituting cellulose has free hydroxyl groups at the 2-position, the 3-position, and the 6-position. Cellulose acylate is a polymer in which a part or all of these hydroxyl groups are esterified by an acyl group having 2 or more carbon atoms. The acyl substitution degree indicates the percentage of esterified hydroxyl groups of cellulose positioned at the 2-position, the 3-position, and the 6-position in all hydroxyl groups (100% of esterification is the substitution degree 1).

The total of acyl substitution degrees, that is, DS2+DS3+DS6 is preferably in a range of 1.5 to 3.0, more preferably in a range of 2.0 to 3.0, still more preferably in a range of 2.5 to 3.0, even still more preferably in a range of 2.7 to 3.0, and particularly preferably in a range of 2.70 to 2.98. Further, from the viewpoint of film forming properties, the total of acyl substitution degrees is preferably in a range of 2.80 to 2.95 and particularly preferably in a range of 2.85 to 2.90. Here, DS2 is a substitution degree resulting from an acyl. group of a hydroxyl group at the 2-position of a glucose unit (hereinafter, also referred to as an “acyl substitution degree at the 2-position”); DS3 is a substitution degree resulting from an acyl group of a hydroxyl group at the 3-position (hereinafter, also referred to as an “acyl substitution degree at the 3-position”); and DS6 is a substitution degree resulting from an acyl group of a hydroxyl group at the 6-position (hereinafter, also referred to as an “acyl substitution degree at the 6-position”). Further, “DS61(DS2+DS3+DS6)” indicates the percentage of the acyl substitution degree at the 6-position to the total of acyl substitution degrees and, is also referred to as an “proportion of acyl substitution at the 6-position”.

In regard to the molecular weight of cellulose acylate, the number average molecular weight (Mn) is preferably in a range of 40000 to 200000 and more preferably in a range of 100000 to 200000. The ratio between Mw and Mn of the cellulose acylate used in the present invention is preferably 4.0 or less and more preferably in a range of 1.4 to 2.3.

In the present invention, the average molecular weight and molecular weight distribution of cellulose acylate or the like can be obtained by calculating the number average molecular weight (Mn) and the weight-average molecular weight (Mw) using gel permeation chromatography (GPC) and the ratio between the number average molecular weight (Mn) and the weight-average molecular weight (Mw) can be calculated using a method described in WO2008/126535A.

The type of acyl group of cellulose acylate is not particularly limited, but an acyl group having 2 to 10 carbon atoms is preferable; an acyl group having 2 to 6 carbon atoms is more preferable; and an acyl group having 2 to 4 carbon atoms is still more preferable. Specifically, it is preferable that the acyl group of cellulose acylate is an acetyl group or a propionyl group and particularly preferable that the acyl group of cellulose acylate is an acetyl group. That is, it is preferable that cellulose acylate is cellulose acetate.

The cellulose acylate being used may contain one or more additives such as a plasticizer or an ultraviolet (UV) absorber within the range not departing from the claims of the present invention. The amount of additives to he added is not particularly limited, but its preferably 30% by weight or less, more preferably in a range of 3% to 25% by weight, and most preferably in a range of 3% to 20% by weight, from the viewpoints of transparency and bleed out.

The additive being used is not particularly limited, and, for example, an ester oligomer (aromatic ester oligomer) containing an aromatic dicarboxylic acid can he used. An aromatic dicarboxylic acid-containing ester oligomer has a repeating unit derived from a dicarboxylic acid and a repeating unit derived from a diol and m:n is preferably in a range of 0:10 to 3:7 when the molar ratio of the repeating unit derived from an aliphatic dicarboxylic acid to the repeating unit derived from a dicarboxylic acid is set to m and the molar ratio of the repeating unit derived from an aromatic dicarboxylic acid to the repeating unit derived from a dicarboxylic acid is set to n. In regard to the molecular weight, the number average molecular weight (Mn) is preferably in a range of 600 to 3000, more preferably in a range of 600 to 2000, and still more preferably in a range of 600 to 1500.

It is preferable that an aromatic ester oligomer to be used is synthesized from a diol having 2 to 10 carbon atoms and a dicarboxylic acid having 4 to 10 carbon atoms. As the synthesis method, known methods such as a dehydration condensation reaction of a dicarboxylic acid and a diol or addition of dicarboxylic anhydride to glycol and a dehydration condensation reaction can be used. It is preferable that an aromatic ester oligomer is a polyester-based oligomer obtained by synthesizing an aromatic dicarboxylic acid which is a dicarboxylic acid and a diol.

Further, additives of the acylate film used in the present invention can be referred to paragraphs 0039 to 0063 and 0068 to 0095 of JP2013-117009A.

(Method of Producing Cellulose Acylate Film)

A method of producing a cellulose acylate film is not particularly limited and the film can be formed using a known method. For example, the film formation can be carried out using any one of a solution casting film forming method and a melt film forming method. From the viewpoint of smoothness of a film, it is preferable that the cellulose acylate film is produced using a solution casting film forming method. Hereinafter, a case of using a solution casting film forming method will be described as an example, but the present invention is not limited to the solution casting film forming method. Further, a known method can be used in a case where a melt film funning method is used.

—Polymer Solution—

In the solution casting film forming method, a web is formed using a polymer solution (cellulose acylate solution) containing cellulose acylate and various additives if necessary. Hereinafter, a polymer solution (hereinafter, also referred to as a cellulose acylate solution) which can be used for the solution casting film forming method will be described.

—Solvent—

The cellulose acylate used in the present invention is dissolved in a solvent to form, a dope and the dope is cast on a base, thereby forming a film. At this time, since it is necessary to extrude or evaporate the solvent after the casting, a volatile solvent is preferably used.

In addition, a solvent which does not react with a reactive metal compound or a catalyst and does not dissolve a base for casting is preferably used. Further, two or more kinds of solvents may be mixed and then used.

Moreover, cellulose acylate and a hydrolysis polycondensable reactive metal compound may be respectively dissolved in different solvents and then mixed with each other.

Here, an organic solvent having excellent solubility with respect to the above-described cellulose acylate is referred to as a good solvent and an organic solvent that exhibits the main effect for dissolution and is used in a large amount among solvents is referred to as a main (organic) solvent or a principal (organic) solvent.

Examples of the good solvent include ketones such as acetone, methyl ethyl ketone, cyclopentanone, and cyclohexanone, ethers such as tetrahydrofuran (THF), 1,4-dioxane, 1,3-dioxolane, and 1,2-dimethoxyethane, esters such as methyl formate, ethyl formate, methyl acetate, ethyl acetate, amyl acetate, and γ-butyrolactone, methyl cellosolve, dimethyl imidazolinone, dimethyl formamide, dimethyl acetamide, acetonitrile, dimethyl sulfoxide, sulfolane, nitroethane, methylene chloride, and methyl acetoacetate. Among these, 1,3-dioxolane, THF, methyl ethyl ketone, acetone, methyl acetate, and methylene chloride are preferable.

It is preferable that the dope contains 1% to 40% by mass of alcohol having 1 to 4 carbon atoms in addition to the above-described organic solvent.

These solvents play roles of gelling a web (a dope film after the dope of cellulose acylate is casted on the metal support is referred to as a web) by being evaporated so that the ratio of alcohol is increased after the dope is casted on the metal support to he used as a gelled solvent that facilitates peeling from the metal support, promoting dissolution of cellulose acylate of a non-chlorine organic solvent when the percentage of these solvents is small, and suppressing gelling, precipitation, and an increase in viscosity of a reactive metal compound.

Examples of alcohol having 1 to 4 carbon atoms include methanol, ethanol, n-propanol, iso-propanol, n-butanol, sec-butanol, tert-butanol, and propylene glycol monomethyl ether.

Among these, from the viewpoints of excellent stability Of a dope, a relatively low boiling point, excellent drying properties, and non-toxicity, methanol or methanol is preferable. Further, ethanol is most preferable. When these organic solvents are used alone, the solvent does not have solubility with respect to cellulose acylate and is referred to as a poor solvent.

Since cellulose acylate which is a raw material of cellulose acylate includes a hydrogen-bonding functional group of a hydroxyl group, ester, or ketone, it is desired that the cellulose acylate contains preferably 5% to 30% by mass of alcohol, more preferably 5% to 25% by mass of alcohol, and still more preferably 8% to 20% by mass of alcohol in all solvents, from the viewpoint of peeling from a casting support.

Further, when cellulose acylate contains a small amount of water, this is effective for increasing the solution viscosity or the film hardness in a wet film state at the time of drying or the dope strength at the time of casting according to a drum method. Therefore, for example, the content of water is preferably in a range of 0.1% to 5% by mass, more preferably in a range of 0.1% to 3% by mass, and particularly preferably in a range of 0.2% to 2% by mass with respect to the total mass of all solvents.

Examples of combinations of organic solvents preferably used as solvents of the polymer solution of the present invention include those described in JP2009-262551A.

Further, if necessary, a non-halogen organic solvent can be used as a main solvent and the details thereof are described in JIII Journal of technical disclosure (No. 2001-1745, published on Mar. 15, 2001, JIII).

The concentration of cellulose acylate in the polymer solution is preferably in a range of 5% to 40% by mass, more preferably in a range of 10% to 30% by mass, and still more preferably in a range of 15% to 30% by mass.

The concentration of cellulose acylate can be adjusted to a predetermined concentration in the stage of dissolving cellulose acylate in a solvent. Further, a solution having a low concentration (for example, 4% to 14% by mass) is prepared in advance and then the solution may be concentrated by evaporating the solvent. Further, a solution having a high concentration is prepared in advance and then the solution may be diluted. In addition, the concentration of cellulose acylate can be decreased by adding an additive thereto.

The timing of adding an additive can be appropriately determined according to the type of additive. For example, an aromatic ester oligomer or an ultraviolet absorbing, agent may be added to a dope after an ultraviolet absorbing agent is dissolved in organic solvents such as alcohol such as methanol, ethanol, or butanol, methylene chloride, methyl acetate, acetone, and dioxolane or mixed solvents of these or may be directly added to the dope composition. An additive which is not dissolved in an organic solvent, such as inorganic powder, is added to a dope after a dissolver or a sand mill is used in an organic solvent and cellulose acylate and then dispersed therein.

A solvent that is most preferable as a solvent that dissolves cellulose acylate, which is a preferred polymer compound satisfying the above-described conditions, at a high concentration is a mixed solvent of methylene chloride and methyl alcohol at a mixing ratio of 95:5 to 80:20. Alternatively, a mixed solvent of methyl acetate and methyl alcohol at a mixing ratio of 60:40 to 95:5 is also preferably used.

(1) Dissolving Process

A dissolving process is a process of dissolving cellulose acylate and an additive in organic solvents mainly having good solvents with respect to cellulose acylate while stirring cellulose acylate and the additive in a dissolving pot to form a dope or a process of mixing an additive solution with a cellulose acylate solution to form a dope.

For dissolution of cellulose acylate, various dissolution methods such as a method of dissolving cellulose acylate at a normal pressure, a method of dissolving cellulose acylate at a boiling point or lower of a main solvent, a method of dissolving cellulose acylate under pressure at a boiling point or higher of a main solvent, a method of dissolving cellulose acylate using a cooling dissolution method as described in JP1997-95544A (JP-H09-95544A), JP1997-95557A (JP-H09-95557A), or JP1997-95538A (JP-H09-95538A), and a method of dissolving cellulose acylate at a high temperature as described in JP1999-71379A (JP-H11-21379A) can be used, hut a method of dissolving cellulose acylate under pressure at a boiling point or higher of a main solvent is particularly preferable.

The concentration of cellulose acylate in the dope is preferably in a range of 10% to 35% by mass. It is preferable that an additive is added to the dope during or after dissolution and then dissolved or dispersed therein, filtered using a filter medium, defoamed, and then sent to the next process using a liquid feed pump.

(2) Casting Process

A casting process is a process of feeding the dope to a pressure die through the liquid feed pump (for example, a pressurized quantitative gear pump) and casting the dope on a casting position of an endless metal belt used for infinite transportation, for example, a stainless belt or a metal support such as a rotating metal drum from a pressure die slit.

A pressure die in which the slit shape of a cap portion of a die can be adjusted and the film thickness can be easily made to be uniform is preferable. Examples of the pressure die include a coat hanger die and a T-die, and these are preferably used. The surface of the metal support is formed of a mirror. Two or more pressure dies are provided on a metal support for increasing the film forming speed and may he overlaid on each other by dividing the dope amount thereof. Alternatively, it is also preferable to obtain a film having a laminate structure according to a co-casting method of casting a plurality of dopes at the same time.

(3) Solvent Evaporation Process

A solvent evaporation process of heating a web (a state before a cellulose acylate film is made into a finished product and a large amount of solvent is contained in this state) on the metal support and allowing a solvent to be evaporated until the web becomes peelable from the metal support.

In order to evaporate the solvent, a method of blowing air from the web side and/or a method of transferring heat using a liquid from the back surface of the metal support, or a method of transferring heat from the front and back surfaces of the metal support using radiation heat can be used. Among these, from the viewpoint of drying efficiency, a method of transferring heat using a liquid from the back surface of the metal support is more preferable. In addition, a method of combining these is also preferable. In a case of transferring heat using a liquid from the back surface of the metal support, it is preferable that the heating is carried out at a boiling point or lower of a main solvent of organic solvents used for the dope or an organic solvent having the lowest boiling point.

(4) Peeling Process

A peeling process is a process of peeling the web in which the solvent on the metal support is evaporated at a peeling position. The web which is peeled off is sent to the next process. Further, the web is unlikely to be peeled off when the amount of residual solvent (the following equation) of the web is extremely large at the time of peeling. On the contrary, a part of the web is peeled off in the middle of the peeling process when the web is peeled after being sufficiently dried on the metal support.

Here, as a method of increasing the film forming speed (the film forming speed can be increased by peeling the web while the amount of residual solvent is as large as possible), a gel casting method may be exemplified. Examples of the gel casting method include a method of adding a poor solvent with respect to cellulose acylate to the dope for gelation after dope casting and a method of decreasing the temperature of the metal support for gelation. When the strength of the film at the time of peeling is increased after gelation on the metal support, the peeling can be made earlier and the film forming speed can be increased.

It is preferable that the web is peeled in a range of 5% to 150% by mass of residual solvent at the time of peeling of the web from the metal support, and the amount thereof depends on the intensity of drying condition or the length of the metal support. In a case where the web is peeled at the time when the amount of residual solvent is larger, the amount of residual solvent during the peeling is determined by the balance between the cost efficient rate and the quality. In the present invention, the temperature at the peeling position on the metal support is preferably in a range of −50° C. to 40° C., more preferably in a range of 10° C. to 40° C., and most preferably in a range of 15° C. to 30° C.

Moreover, the amount of residual solvent of the web at the peeling position is preferably in a range of 10% to 150% by mass and more preferably in a range of 10% to 120% by mass.

The amount of residual solvent can be represented by the following equation.

Amount of residual solvent (% by mass)=[(M−N)/N]×100

Here, M represents the mass of web at an arbitrary time point and N represents the mass of web after the web having the mass M is dried at 110° C. for 3 hours.

(5) Drying or heat treatment process and stretching process

After the peeling process, it is preferable that the web is dried using a drying device that conveys the web alternately passing through a plurality of rolls disposed in the drying device and/or a tentering device that conveys the web by clipping both ends of the web with clips.

In a case where a heat treatment is performed, the heat treatment temperature is lower than Tg −5° C., preferably Tg −20° C. or higher and lower than. Tg −5° C., and more preferably Tg −15° C. or higher and lower than Tg −5° C.

In addition, the time of the heat treatment is preferably 30 minutes or less, more preferably 20 minutes or less, and particularly preferably approximately 10 minutes.

As means for drying and the heat treatment, means for blowing hot air to both surfaces of the web is typically used, but means for heating both surfaces by applying a microwave in place of hot air is also Bused. The temperature, the air volume, and the time vary depending on the solvent being used and conditions may be suitably selected according to the type of solvent to be used and the combination of solvents.

The stretching treatment may be performed in any direction of MD and Ti) or biaxially performed in both directions. From the viewpoint of dimensional stability, biaxial stretching is preferable. The stretching may be performed in one stage or multiple stages. Moreover, the tensile elasticity can be adjusted to be in the above-described range by adjusting the type of cellulose acylate being used or the acyl substitution degree, selecting the type of additive, or adjusting the ratio thereof.

The stretching ratio during the stretching in a film conveyance direction MD is preferably in a range of 0% to 20%, more preferably in a range of 0% to 15%, and particularly preferably in a range of 0% to 10%. The stretching ratio (elongation) of web during the stretching can be achieved by a circumferential speed difference between the metal support speed and the. stripping speed (stripping roll draw). For example, in a case where a device having two nip rollers is used, a film can be preferably stretched in the conveyance direction (machine direction) by increasing the rotational speed of the nip roller on the outlet side more than the rotational speed of the nip roller on the inlet side. The tensile elasticity of MD can be adjusted by performing the stretching in this maimer.

Further, the “stretching ratio (%)” here indicates a ratio obtained by the following equation.

Stretching ratio (%)=100×{(length after stretching)−(length before stretching)}/length before stretching

The stretching ratio during the stretching in the direction TD perpendicular to the film conveyance direction is preferably in a range of 0% to 30%, more preferably in a range of 1% to 20%, and particularly preferabl in a range of 2% to 15%.

In the present invention, as a method of performing stretching in the direction TD perpendicular to the film conveyance direction, it is preferable that the stretching is performed using a tentering device.

A desired retardation value can be obtained through relaxation to 0.8 to 1.0 time in the machine direction during the biaxial stretching. The stretching ratio is set according to the target optical characteristic. In a case where a cellulose acylate film is produced, monoaxial stretching can be performed in the longitudinal direction.

It is preferable that the temperature during stretching is Tg or lower because the tensile elasticity in the stretching direction is increased. The stretching temperature is preferably in a range of Tg −50° C. to Tg and more preferably in a range of Tg −30° C. to Tg −5° C. In addition, when the film is stretched under the temperature conditions, there is a tendency that the tensile elasticity in the stretching direction is increased and the tensile elasticity in the direction perpendicular to the stretching direction is decreased. Accordingly, in order to increase the tensile elasticity in the both directions of MD and TD due to the stretch, it is preferable that a stretching treatment, that is, a biaxial stretching treatment is carried out in both directions in the above-described temperature range.

Further, drying may be carried out after the stretching process. In a case where drying is carried out after the stretching process, the drying temperature, the drying air volume, and the drying time vary depending on the solvent being used and drying conditions may be appropriately selected according to the type of solvent being used and the combination of solvents. In the present invention, from the viewpoint of increasing the from contrast when a film is incorporated in a liquid crystal display device, it is preferable that the drying temperature after the stretching process is lower than the stretching temperature of the stretching process.

(6) Winding

The film obtained in the above-described manner is wound up with a film length of preferably in a range of 100 to 10000 m, more preferably in a range of 500 to 7000 m, and still more preferably in a range of 1000 to 6000 m per one roll. The width of the film is preferably in a range of 0.5 to 5.0 m, more preferably in a range of 1.0 to 3.0 m, and still more preferably in a range of 1.0 to 2.5 m. During the winding, it is preferable that a knurling is provided on at least one end, and the width of the knurling is preferably in a range of 3 to 50 mm and more preferably in a range of 5 to 30 mm and the height thereof is preferably in a range of 0.5 to 500 μm and more preferably in a range of 1 to 200 μm. The winding may be carried out through pressing one side or both sides.

The web obtained in the above-described manner is wound up, thereby obtaining a cellulose acylate film.

(Roll-Shaped Cellulose Acylate Film)

As the cellulose acylate film, a roll-shaped cellulose acylate film formed by winding a long cellulose acylate film into a roll shape may be used. The length or the width of the roll-shaped film is not limited, but the length thereof is preferably in a range of 1300 m to 10400 m, more preferably in a range of 2600 m to 10400 m, and most preferably in a range of 3900 m to 9800 m. From the viewpoint of production efficiency, it is preferable that the film is long, but there are concerns on deformation due to the weight of the film and handling when the film is extremely long. The width thereof is preferably in a range of 1000 mm to 3000 mm, more preferably in a range of 1150 ram to 2800 mm, and most preferably in a range of 1300 mm to 2500 mm.

(Layer Configuration)

The cellulose acylate film may be a single layer film or may have a laminate structure of two or more layers. A laminate structure formed of two layers of a core layer and an outer layer (also referred to as a surface layer or a skin layer) or a laminate structure formed of three layers of an outer layer, a core layer, and an outer layer is also preferable and an embodiment in which these laminate structures are formed by co-casting is also preferable.

In a case where the cellulose acylate film has a laminate structure of two or more layers, it is preferable that a matting agent is added to the outer layer. As the matting agent, agents described in JP2011-127045A may be used and, for example, silica particles having an average particle size of 20 nm can be used.

<Conductive Layer>

The conductive layer contains fullerene functionalized carbon nanotubes. The fullerene functionalized carbon nanotubes will he described below.

The thickness of the conductive layer is less than 10 μm. From the viewpoint of more excellent light transmittance of the conductive film, the thickness thereof is preferably 9 μm, more preferably 8 μm or less, and still more preferably 7 μm or less. The lower limit thereof is not particularly limited, but is preferably 1 μm or greater, more preferably 2 μm or greater, and still more preferably 3 μm or greater from the viewpoint of conductivity of the conductive film.

When the thickness of the conductive layer is adjusted to less than 10 μm, the degree of light absorption due to the fullerene functionalized carbon nanotubes can be decreased.

In addition, the above-described thickness is an average value obtained by measuring the thicknesses of arbitrary 10 points of the conductive layer and arithmetically averaging the values.

The content of fullerene functionalized carbon nanotubes in the conductive layer is not particularly limited, but is preferably 60% by mass or greater, more preferably 80% by mass or greater, and still more preferably 90% by mass with respect to the total mass of the conductive layer, from the viewpoints of more excellent flatness of the conductive film (hereinafter, simply also referred to as “from the viewpoint of more excellent effects of the present invention”) and/or more excellent conductivity of the conductive layer. The upper limit thereof is not particularly limited, but is typically 100% by mass.

Further, the conductive layer may contain additives other than the fullerene functionalized carbon nanotubes and the content thereof is not particularly limited, but is preferably in a range of 0.01% to 40% by mas, more preferably in a range of 0.1% to 20% by mass, and still more preferably in a range of 0.1% to 10% by mass with respect to the total mass of the conductive layer from the viewpoints of more excellent effects of the present invention anchor more excellent conductivity of the conductive layer.[0063] The conductive layer may be disposed on at least one surface or both surfaces of the support. In a case where the conductive layer is disposed on both surfaces of the support, the hard coat layer described below is disposed adjacent to conductive layers respectively disposed on both surfaces of the support.

The conductive layer may be disposed on the entire surface (main surface) of the support or on a region which is a part of the surface of the support. Particularly, in a case where the conductive layer is applied to a touch panel as described below, it is preferable that the conductive layer is disposed in a predetermined pattern.

A method of preparing a conductive layer is not particularly limited as long as a conductive layer containing fullerene functionalized carbon nanotubes is prepared, and examples thereof include a method of allowing fullerene functionalized carbon nanotubes to be dispersed in a solvent to be applied onto a support and performing a drying treatment as needed and a method of blowing aerosols containing fullerene functionalized carbon nanotubes to a support.

Moreover, other than a method of preparing a conductive layer directly on a support, a method of preparing a conductive layer containing fullerene functionalized carbon nanotubes on a temporary support and transferring the conductive layer onto a support may be exemplified.

As described above, the conductive layer may be disposed in a predetermined pattern.

A method of forming a conductive layer in a predetermined pattern is not particularly limited, and examples thereof include a method of depositing a conductive layer containing fullerene functionalized carbon nanotubes on a support on which a mask is provided in a predetermined pattern and removing the mask to obtain a conductive layer having a predetermined pattern; a method of preparing a resist having a predetermined pattern on a conductive layer and performing etching through a wet process using a strong acid, a chemical agent having excellent oxidizability or corrosivity, and a strong alkali; and a method of patterning a conductive layer through screen printing. In the present invention, it is preferable that the conductive layer is patterned by a dry etching process.

An example thereof is described below, but the present invention is not limited thereto.

An aluminum film which becomes a mask is formed on a conductive layer and then the aluminum film is coated with a resist for forming a pattern. Next, the resist together with a pattern are exposed to light and developed. Subsequently, the aluminum film is etched using the patterned resist as a mask. Next, the resist is peeled off. Further, the conductive layer exposed to the surface is burned for removal using a dry etching device, for example, an O₂ plasma ashing device. Here, the burning is used for a method of oxidizing using an O₂ plasma and a radical activated without increasing the substrate temperature as well as a case where the sample temperature is increased, that is, the burning includes ashing. Finally, the conductive layer can be patterned by removing the aluminum film on the conductive layer through wet etching using phosphoric acid, particularly, heated phosphoric acid.

Moreover, the dry etching has been described using 02 plasma ashing, but etching can be carried out using other dry etching methods such as sputtering etching, chemical etching, reactive etching, reactive sputtering etching, ion beam etching, and reacting ion beam etching.

Gas etching or radical-containing etching is chemical etching or reactive etching and is capable of removing nanoparticles mainly containing fullerene functionalized carbon nanotubes or carbon using reactive gas such as oxygen or hydrogen which reacts with carbon and can be removed. The carbon bonds of fullerene functionalized carbon nanotubes, carbon nanoparticles, or amorphous carbon covering a catalytic metal surface are formed of 6-membered rings or 5-membered rings, but the carbon bonds of carbon nanoparticles or amorphous carbon covering a catalytic metal surface are incomplete compared to fullerene functionalized carbon nanotubes so that the amount of 5-membered rings is larger and easily react with reactive gas.

Accordingly, in a case where a conductive layer containing carbon nanoparticles or fullerene functionalized carbon nanotubes that include amorphous carbon covering the catalytic metal surface is patterned, gas etching or radical-containing etching is more effective. Further, since gas etching or radical-containing etching is isotropic etching, reactive gas runs around not only the surface of nanotubes to be patterned but also the side wall or back surface of nanotubes and nanoparticles in the vicinity of the, surface and selectively reacts with carbon so that the portion other than catalytic metal can be rapidly removed. In addition, a conductive layer containing fullerene functionalized carbon nanotubes that include nanoparticles can be patterned by adding a process of removing only the catalytic metal. For example, in a case where the reaction product is oxygen, the reaction product becomes gas such as CO or CO₂ and thus does not re-adhere to the support. Therefore, there is no problem of surface contamination. Particularly, the burning using oxygen is simply carried out, which is preferable.

Next, a case of using ionic sputtering effects is considered. For example, aluminum is covered on a conductive layer which is intended to be left at the time of patterning using sputtering or vapor deposition, but aluminum is unlikely to be sufficiently covered particularly in the inside of a concave in a case where the surface of the conductive layer is significantly uneven. In a case of using reactive gas, gas pans around, and the conductive layer is etched from a portion in which a protective film is not sufficiently covered in a case where the etching time is long. Meanwhile, since the straightness of ion species is strong and the ion species enter from the upper surface in a case of using ionic sputter etching, it is difficult to damage the conductive layer positioned below the thick covered film. Further, because of anisotropic etching, etching can be made reliably and vertically to the mask pattern. Therefore, this is preferable for removing the conductive layer containing fullerene functionalized carbon nanotubes in which nanoparticles do not contain catalytic metal and also preferable for forming a fine pattern.

In ion beam etching or reactive ion beam etching, etching can be performed without mask, but modulation of beams and the process time per area are required. Further, a small-sized display is suitable here than a large area display.

Further, the example using an aluminum film as a mask during the above-described O₂ plasma ashing has been described, metals, such as titanium, gold, molybdenum, tungsten, and silver, which do not damage the conductive layer during the removal of the conductive layer may be used. The conductive layer can be rapidly removed by a mixed solution of titanium and nitric acid, gold and aqua regia, molybdenum and hot-concentrated sulfuric acid or aqua regia, or tungsten and hydrofluoric acid or nitric acid. However, since the conductive layer is gradually degraded when nitric acid, sulfuric acid, and hydrogen fluoride are used during a long-time process, it is necessary to perform the process, particularly, under conditions of the temperature and the concentration in a predetermined time, which are not damaged. The process can be performed without damage by carrying out the process at room temperature in one hour using 65% of nitric acid, 90% of sulfuric acid, 45% of hydrogen fluoride, and a mixture of these. Aluminum is preferred than other metals since aluminum is inexpensive compared to other metals and is in a state of the conductive layer being covered, in which aluminum crystal grains are dense and the coverage is high, and the conductive layer is not degraded with respect to phosphoric acid which is an etching solution.

Meanwhile, a metal with a large atomic weight has a small sputtering rate due to ions and is suitable as a mask material in a case of dry etching mainly having sputtering effects. Particularly, gold, tungsten, and molybdenum have resistance at least two times the resistance of aluminum of titanium and thus are unlikely to be damaged immediately below a mask. Therefore, it is preferable that the conductive layer containing fullerene functionalized carbon nanotubes in which nanoparticles do not contain catalytic metal is removed and the removal is preferable for forming a fine pattern.

Moreover, other than metals, silicon dioxide or aluminum oxide which is not damaged by O₂ plasma ashing and does not damage the conductive layer during the removal can be used.

(Fullerene Functionalized Carbon Nanotubes)

The fullerene functionalized carbon nanotubes (in the present specification, also referred to as CBFFCNT) include one or plural fullerenes and/or fullerene-based molecules covalently bonded to carbon nanotubes. That is, CBFFCNT is a carbon nanotube in which one or plural kinds selected from the group consisting of fullerenes and fullerene-based molecules are introduced through a covalent bond.

Further, a carbon nanotube is a substance in which a six-membered ring network (graphene sheet) resulting from carbon atoms is turned into a coaxial tubular monolayer or multilayer. A carbon nanotube may be configured of only carbon atoms or may include carbon atoms and one or plural kinds of other atoms (for example, heteroatoms). A carbon nanotube may have a cylindrical or tubular structure whose terminal is open and/or closed. Moreover, a carbon nanotube may have other kinds of carbon nanotube structures.

A fullerene is a molecule which includes carbon atoms and has a substantially spherical, oval, or ball-like structure. A fullerene may have a hollow structure whose surface is closed or a substantially spherical structure whose surface is not completely closed and which has one or plural open bonds. A fullerene may have a substantially hemispheric shape and/or a shape of another arbitrary sphere.

Fullerene-based molecules are any of the above-described fullerenes, one or plural carbon atoms in a molecule are one or plural atoms other than carbon atoms (for example, heteroatoms), molecules, molecules substituted with groups and/or compounds, or the above-described fullerene molecules; one or plural additional atoms (for example, heteroatoms), molecules, molecules in which groups and/or compounds are incorporated in fullerenes, or the above-described fullerenes; or one or plural additional atoms (for example, heteroatoms), molecules, or molecules in which groups and/or compounds adhere to the surface of fullerenes.

In addition, the point in which one or plural other fullerenes can adhere to the surface of carbon nanotubes may be mentioned, but this is a simply one non-limiting example. One or plural fullerenes and/or fullerene-based molecules can be covalently bonded to the outer surface and/or inner surface of carbon nanotubes, preferably the outer surface thereof. The fullerenes and/or fullerene-based molecules may contain 20 to 1000 atoms. The fullerene and/or fullerene-based molecules may be covalently bonded to carbon nanotubes through one or plural crosslinking atomic groups or may be covalently bonded directly to carbon nanotubes.

The crosslinking atomic groups indicate arbitrary atoms, elements, molecules, groups, and/or compounds used to allow fullerenes and/or fullerene-based molecules to be covalently bonded to carbon nanotubes. Preferred crosslinking atomic groups may include arbitrary elements of Group IV, Group V, and Group VI of the periodic table of elements. The preferred crosslinking atomic groups may include oxygen, hydrogen, nitrogen, sulfur, an amino group, a thiol group, an ether group, an ester group, and/or a carboxylic acid group, and/or other arbitrary preferred groups, and/or derivatives thereof. The preferred crosslinking atomic groups may include a carbon-containing group.

Further, as described above, as another option or in addition to the above-described options, the fullerenes and/or fullerene-based molecules may be covalently bonded directly to carbon nanorabes. For example, the fullerenes and/or fullerene-based molecules may he covalently bonded directly thereto through one or plural carbon bonds.

Carbon nanotubes may include single-wail, double-wall, or multi-wail carbon nanotubes or composite carbon nanotubes. Carbon nanotubes can be blended in a dispersion of a gas, a liquid, and/or a solid, a solid structure, powder, paste, and/or a colloidal suspension, and/or can be precipitated on the surface, and/or can be synthesized.

The fullerene functionalized carbon nanotubes can be bonded to one or plural carbon nanotubes and/or fullerene functionalized carbon nanotubes through one or plural fullerenes and/or fullerene-based molecules. In other words, for example, two fullerene functionalized carbon nanotubes can adhere to each other through common fullerene molecules.

(Method of Producing Fullerene Functionalized Carbon Nanotubes)

A method of producing one or plural fullerene functionalized carbon nanotubes includes allowing one or plural catalyst particles, carbon sources, and/or reagents to come into contact with each other to be heated in a reactor and producing one or plural carbon nanotubes containing one or plural fullerenes and/or fullerene-based molecules covalently bonded to one or plural carbon nanotubes.

A step of allowing one or plural catalyst particles, carbon sources, and/or reagents to come into contact with each other can be performed according to an arbitrary suitable method (for example, mixing) of bringing those into contact with each other. It is preferable that this method is performed in a reactor. In this manner, one or plural fullerene functionalized carbon nanotubes are produced.

The fullerene functionalized carbon nanotubes can be produced in a gas phase such as an aerosol and/or on a base. Further, this method may be carried out by a continuous flow, a hatch process, or a combination of a batch sub-process and a continuous sub-process.

When the fullerene functionalized carbon nanotubes are produced, various carbon-containing materials can be used as carbon sources. Further, a carbon-containing precursor that forms a carbon source can be used. A carbon source can be selected from the group consisting of one or plural alkanes, alkenes, alkynes, alcohols, aromatic hydrocarbons, and arbitrary other suitable groups, compounds, and materials. Further, a carbon source can be selected from the group consisting of carbon compounds of a gas (methane, ethane, propane, ethylene, acetylene, carbon monoxide, and the like), volatile carbon sources of a liquid (benzene, toluene, xylene, trimethylbenzene, methanol, ethanol, octanol, and the like), other arbitrary suitable compounds, and derivatives thereof. Thiophene can be also used as a carbon source. Among these, carbon monoxide gas is preferable as a carbon source.

Carbon sources can be used alone or in plural kinds thereof.

In a case where a carbon precursor is used, the carbon precursor can be activated desired location in a reactor using a heated filament or plasma.

According to one embodiment, one or plural carbon sources function as one or plural catalyst particle sources, reagents, reagent precursors, and/or additional reagents.

5 to 10000 ccm and preferably 50 to 1000 corn of a carbon source can be introduced into a reactor at a rate of approximately 300 ccm. The pressure of various materials (for example, carbon sources) used for this method can be set to be in a range of 0.1 to 1000 Pa and preferably in a range of 1 to 500 Pa.

One or plural reagents can be used for producing fullerene functionalized carbon nanotubes. A reagent may be an etching agent. A reagent can be selected from the group consisting of hydrogen, nitrogen, water, carbon dioxide, nitrous oxide, nitrogen dioxide, and oxygen. Further, a reagent can be selected from organic and/or inorganic oxygen-containing compounds (ozone (O₃) and the like) and various hydrides. One or plural reagents used for this method can be selected from carbon monoxide, octanol, and/or thiophene.

A preferable reagent (one or plural kinds) is water vapor and/or carbon dioxide. Further, other arbitrary suitable reagents can be used for the method of the present invention. Other reagents and/or reagent precursors can be used as carbon sources. On the contrary, carbon sources can be used as reagents and/or reagent precursors. Examples of such reagents include ketone, aldehyde, alcohol, ester, and/or ether, and/or other arbitrary suitable compounds.

One or plural reagents and/or reagent precursors can be introduced into a reactor together with or separately from carbon sources. One or plural reagents and reagent precursors can be introduced into a reactor at a concentration of 1 to 12000 ppm and preferably 100 to 2000 ppm.

The concentration of one or plural fullerenes and/or fullerene-based molecules covalently bonded to carbon nanotubes. The concentration thereof can be adjusted by adjusting the amount (for example, the concentration) of one or plural reagents being used, adjusting the heating temperature, and/or adjusting the retention time. The adjustment is performed according to a synthesis method. The heating can be performed at a temperature of 250° C. to 2500° C. and preferably 600° C. to 1000° C. For example, in a case where H₂O and CO₂ are used as reagents, the concentration of a reagent in a case of water can be set to be in a range of 45 to 245 ppm and preferably in a range of 125 to 185 ppm and the concentration of a reagent in a case of CO₂ can be set to be in a range of 2000 to 6000 ppm and preferably approximately 2500 ppm. In this manner, the fullerene density higher than 1 fullerene/nm can be set. Even at a specific concentration of one or plural reagents, it is possible to find an optimum range of the heating temperature.

Various catalyst materials (catalyst particles) that catalyze decomposition and disproportionation of carbon sources can be used.

Catalyst particles being used may contain, for example, various metals and/or non-metallic materials. Preferable catalyst particles contain one metal and preferably one transition metal and/or metals (plural kinds) and/or a combination of transition metals (plural kinds). It is preferable that catalyst particles contain iron, cobalt, nickel, chromium, molybdenum, palladium, and/or other arbitrary similar elements. The catalyst particles can be formed by thermal decomposition of ferrocene vapor from a chemical precursor (for example, ferrocene). The catalyst particles can be produced by heating a metal or a metal-containing material.

The catalyst particles and the catalyst precursor can be introduced into a reactor at a ratio of 10 to 10000 can and preferably 50 to 1000 ccm (for example, approximately 100 ccm).

The catalyst particles used for the method of the present invention can be produced using various methods. Examples of such methods include chemical vapor decomposition of a catalyst precursor and physical vapor nucleation. Further, as other methods, catalyst particles can be produced from liquid droplets formed from a metal salt solution and a colloidal metal nanoparticle solution using electrospray, ultrasonic spray, or air spray or can be produced using thermal drying and decomposition, and/or other arbitrary applicable methods, and/or processes, and/or materials. Other arbitrary procedures for producing particles, for example, adiabatic expansion in a nozzle, arc discharge, and/or an electrospray system can be used to form catalyst particles. A hot wire generator can be used to produce catalyst particles. According to the present invention, other means for heating and/or evaporating a mass containing a metal used to generate metal vapor can be used.

The catalyst particles can be synthesized in advance and then can be introduced into a reactor. However, since particles having a particle size range required for production of CBFFCNT are difficult to handle and/or store, it is preferable that particles are produced in the vicinity of the reactor as an integrating step in the producing process.

Aerosols and/or catalyst particles carrying the surface can be used to produce fullerene functionalized carbon nanotubes. A catalyst particle precursor can be used to produce catalyst particles.

In a case of producing fullerene functionalized carbon nanotubes carrying a base, catalyst particles can he directly produced on the base and can be precipitated from a gas phase due to diffusion, thentiophoresis, electrophoresis, inertial impaction, and/or other arbitrary means.

In a case of a chemical production method of catalyst particles, a metal organic compound, an organic metal compound, and/or an inorganic compound such as a metallocene compound, a carbonyl compound, a chelate compound, and/or other arbitrary suitable compounds can be used as a catalyst precursor.

In a case of a physical production method of catalyst particles, for example, a pure metal or an alloy thereof is evaporated using resistance heating, induction heating, plasma heating, conductive heating, or radiative heating, or various energy sources such as a chemical reaction (here, the concentration of generated catalyst vapor is lower than the level required for nucleation at a location of release) and then nucleation, condensation, and/or coagulation can be made from supersaturated vapor. As means for generating supersaturated vapor leading to formation of catalyst particles in the physical method, gas cooling using convective heat transfer, conductive heat transfer, and/or radiant heat transfer, and/or adiabatic expansion (for example, in a nozzle) in the periphery of a wire which is resistance-heated may be exemplified.

In a case of a thermal decomposition production method of catalyst particles, for example, various metals and/or other arbitrary suitable materials of inorganic salts such as nitrate, carbonate, a chloride, and/or a fluoride.

The method of present invention may further include a step of introducing one or plural additional reagents. Additional reagents are used to promote formation of carbon nanotubes, change the decomposition rate of carbon sources, react with amorphous carbon during and/or after production of carbon nanotubes, and/or react with carbon nanotubes (for example, for purification of carbon nanotubes, doping, and/or further functionalization) Additional reagents used to associate with chemical reactions with catalyst particle precursors, catalyst particles, carbon sources, amorphous carbon, and/or carbon nanotubes (to which one or plural fullerene and/or fullerene-based molecules are covalently bonded) can be used according to the present invention. One or plural additional reagents can be introduced together with or separately from carbon sources.

As accelerators (that is, additional reagents) for forming CBFFCNT of the present invention, additional reagents such as sulfur, phosphorus, and/or nitrogen elements, and/or compounds of these (thiophene, PH₃, NH₃, and the like) can be used. The additional accelerator reagents can be selected from H₂O, CO₂, NO, and/or arbitrary other suitable elements, and/or compounds.

in some cases, during a purification process, for example, undesirable amorphous carbon coating and/or catalyst particles encapsulated in CBFFCNT are required to be removed. In this present invention, it is possible to provide one or plural separate reactors to he heated and reactor sections and one reactor or one section of the reactor is used to produce CBFFCNT, and the rest (one or plural) are used for further purification, further functionalization, and/or doping. The above-described steps may be combined with each other.

As chemical materials for removing amorphous carbon, an arbitrary compound, a derivative of the compound, and/or a decomposition product of the compound (formed in a reactor instantly) can be used and the chemical substance does not react with graphite carbon but with preferably amorphous carbon. As examples of such reagents, one or plural alcohols, ketones, organic acids, and/or inorganic acids can be used. Further, oxidants such as H₂O, CO₂, and/or NO can be used. According to the present invention, other additional reagents can be also used.

According to one embodiment, one or plural additional reagents can be used for further functionalization of CBFFCNT. The properties of CBFFCNT to be produced are changed by chemical groups and/or nanoparticles adhering to CBFFCNT. When CBFFCNT is doped by boron, nitrogen, lithium, sodium, and/or potassium elements, the conductivity of CBFFCNT is changed. That is, CBFFCNT having superconductivity is obtained. When carbon nanotubes are functionalized by fullerenes, further functionalization of carbon nanotubes becomes possible due to the adhering fullerenes. In the present invention, when appropriate reagents are introduced before, during, and/or after formation of CBFFCNT, functionalization and/or doping can be performed instantly.

According to one embodiment, one or plural additional reagents can be used as carbon sources, carrier gas, and/or catalyst particle sources.

According to one embodiment, this method further includes a step of producing fullerene functionalized carbon nanotube composite materials by introducing one or plural additives into a reactor. For example, one or plural additives can be used to he applied to CBFFCNT and/or to be mixed with CBFFNCT to produce a CBFFCNT composite material. An object of the additive is to increase catalyst efficiency of CBFFCNT adhering to a matrix and/or to control properties the matrix (hardness, stiffness, chemical reactivity, optical characteristics, and/or thermal conductivity, and/or electrical conductivity, and/or an expansion coefficiency). As coating or aerosolized particle additives for a CBFFCNT composite material, preferably, one or plural metal-containing material, and/or organic materials (polymer and the like), and/or ceramics, solvents, and/or aerosols of these can be used. According to the present invention, other arbitrary suitable additives can be used.

For example, the obtained composite material can be directly recovered, adhere to a matrix, and/or adhere to the surface. This can be carried out using electric force, thermophoretic force, inertial force, diffusing force, turbophoretic force, gravity, and/or other suitable forces to form a thick film or a thin film, yarn, a structural body, and/or a layered material. CBFFCNT can be coated with one or more solids or liquids to be added and/or solids or liquid particles to form a CBFFCNT composite material.

The additive is mixed and aggregated in a gas phase to adhere to the surface of CBFFCNT as a surface coating using condensation of supersaturated vapor, a chemical reaction with a layer having adhered in advance, a doping agent, and/or a functional group, and/or other means, alternatively, in a case where the additive is in the form of particles. Further, it is possible to combine adhesion of gas and particles to CBFFCNT.

According to one embodiment, if necessary, one or plural carrier gases can be used to introduce the above-described materials into a reactor. If desired, the carrier gases may function as carbon sources, catalyst particle sources, reagent sources, and/or additional reagent sources.

According to one embodiment, this method further includes a step of recovering produced one or plural fullerene functionalized carbon nanotubes and/or fullerene functionalized carbon nanotube composite materials as a solid, a liquid, a dispersion of gas, a solid structure, powder, paste, a colloidal suspension, and/or a surface deposit.

According to one embodiment, this method further includes a step of allowing a dispersion of produced fullerene functionalized carbon nanotubes and/or fullerene functionalized carbon nanotube composite material, for example, a gas dispersion to adhere to the surface, and/or a matrix, and/or a layered structure, and/or a device.

The adhesion of the synthesized material is controlled by various means (inertial impaction, thermophoresis, and/or movement in an electric field, but not limited to these) so that the material is formed in a desired shape (for example, yarn, points, or a three-dimensional structure) with desirable properties such as electrical conductivity and/or thermal conductivity, opacity and/or mechanical strength, and hardness and/or ductility. Examples of means for controlling adhesion of the synthesized material include gravitational settling, fiber and barrier filtration, inertial impaction, thermophoresis, and/or movement in an electric field, which form the material in a desired shape (for example, yarn, points, or a film) with desirable properties such as electrical conductivity and/or thermal conductivity, opacity and/or mechanical strength, and hardness and/or ductility; but the means is not limited to these.

Hereinafter, a device used to produce one or plural fullerene functionalized carbon nanotubes will be described. This device includes a reactor used for heating one or plural catalyst particles, carbon sources, and/or reagents, and the heating is performed to produce one or plural carbon nanotubes containing one or plural fullerene and/or fullerene-based molecules covalently bonded to one or plural carbon nanotubes.

Such a device may further includes one or more selected from means for producing catalyst particles; means for introducing one or plural catalyst particles; means for introducing one or plural catalyst particle precursors; means for introducing one or plural carbon sources; means for introducing one or plural carbon source precursors; means for introducing one or plural reagents; means for introducing one or plural reagent precursors; means for introducing one or plural additional reagents; means for introducing one or plural additives; means for recovering one or plural produced fullerene functionalized carbon nanotubes and/or fullerene functionalized carbon nanotube composite materials; means for adhering a dispersion (for example, a gas dispersion) of produced fullerene functionalized carbon nanotubes and/or carbon nanotube composite materials; means for producing catalyst particles; and/or means for supplying energy to a reactor. For example, the means used to introduce the above-described various materials to other arbitrary portions of the reactor and/or the device may include one same means or various means. For example, according to one embodiment of the present invention, one or plural carbon sources and reagents can be introduced into the reactor using one same means. Further, if necessary, the device may include mixing means in the reactor.

The device may include one or plural reactors and, accordingly, it is possible to carry out continuous production and/or batch production of composite materials of CBFFCNT, further functionalized CBFFCNT, doped CBFFCNT, and/or CBFFCNT of these. The reactors are configured in series and/or juxtaposition so that various final compositions can be obtained. Further, the reactors can be operated by complete hatch procedures or partial batch procedures.

The reactor may include a tube having ceramic materials, iron, stainless steel, and/or other arbitrary suitable materials. In one embodiment of the present invention, the surface of the reactor may be formed to include materials used to catalytically produce one or plural reagents required for production of CBFFCNT from one or plural reagent precursors introduced into the reactor (for example, in the upstream).

In one embodiment, the internal diameter of the tube can be set to be in a range of, for example, 0.1 to 200 cm and preferably in a range of 1.5 to 3 cm and the length of the tube can be set to be in a range of, for example, 1 to 2000 cm and preferably in a range of 25 to 200 cm. Other arbitrary dimensions (for example, those used for industrial usage) can be applied.

In a case of using the device of the present invention, the operating pressure in the reactor can be set to be in a range of, for example, 0.1 to 10 atm and preferably in a range of 0.5 to 2 atom for example, approximately 1 atm). Further, the temperature in the reactor can be set to be in a range of, for example, 250 to 2500° C. and preferably in a range of 600° C. to 1000° C.

The means for producing catalyst particles may include a pre-reactor. This means may include a hot wire generator. The device may further include other arbitrary suitable means for producing catalyst particles. This means can be separated from the reactor at an interval. Alternatively, this means may be used as a part incorporated in the reactor. In a case of using the device of the present invention, the means for producing catalyst particles can be placed at a position in which the temperature of the reactor is in a range of 250° C. to 2500° C. and preferably in a range of 350° C. to 900° C.

According to one preferred embodiment, for example, a flow passing through a pre-reactor (for example, a hot wire generator) is a mixture of, preferably, hydrogen and nitrogen and the rate of hydrogen here is preferably in a range of 1% to 99%, more preferably in a range of 5 to 50%, and most preferably approximately 7%. The flow rate, for example, the flow rate passing through the hot wire generator can be set to be in a range of 1 to 10000 ccm and preferably in a range of 250 to 600 ccm.

According to the present invention, it is possible to promote and/or inhibit the chemical reaction and/or CBFFCNT synthesis using various energy sources. Examples thereof include a reactor heated by resistance, conduction, radiation, and/or atomic power, and/or the chemical reaction and/or a pre-reactor, but the examples are not limited to these. Other energy sources can be used as a reactor and/or a pre-reactor. For example, induction heating using a high frequency, a microwave, sound, or a laser and/or any other energy sources (chemical reaction and the like) can be used.

<Hard Coat Layer>

A hard coat layer is a layer disposed in adjacent to the above-described conductive layer and has a function of preventing damage to the conductive layer. The hard coat layer is disposed in adjacent to the conductive layer. That is, the hard coat layer and the conductive layer are adjacent to each other.

The pencil hardness (JIS K5400) of the conductive film is increased by forming a hard coat layer. Practically, the pencil hardness of the conductive film after the hard coat layer is laminated is preferably H or greater, more preferably 2H or greater, and most preferably 3H or greater.

The thickness of the hard coat layer is preferably in a range of 0.4 to 35 μm, more preferably in a range of 1 to 30 μm, and still more preferably in a range of 1.5 to 20 μm.

The hard coat layer may be a single layer or multiple layers. In a case where a plurality of hard coat layers are present, it is preferable that the total film thickness of all hard coat layers is in the above-described range.

Moreover, if necessary, the hard coat layer may contain light-transmitting particles for improving surface unevenness or providing internal scattering.

A method of forming a hard coat layer is not particularly limited, and a known method may be employed. Typically, a method of coating the conductive layer with a composition for forming a hard coat layer which contains a predetermined component and performing a curing treatment (for example, a heat treatment and/or a light irradiation treatment) as needed.

An embodiment of the composition for forming a hard coat layer will be described later.

A known coating method can be employed as the coating method. Examples thereof include gravure coating, roll coating, reverse coating, knife coating, die coating, lip coating, doctor coating, extrusion coating, slide coating, wire bar coating, curtain coating, extrusion coating, and spinner coating.

After the conductive layer is coated with the composition for forming a hard coat layer, if necessary, a drying treatment may be performed to the layer coated with the composition in order to remove a solvent. The method of the drying treatment is not particularly limited, and examples thereof include an air drying treatment and a heat treatment.

A method of polymerizing and curing the layer coated with the composition obtained by the above-described coating is not particularly limited, and examples thereof include a heat treatment and a light irradiation treatment.

The conditions for the heat treatment vary depending on the material to be used, but it is preferable that the heat treatment is performed at 40° C. to 200° C. (preferably in a range of 50° C. to 150° C.) for 0.5 minutes to 10 minutes (preferably in a range of 1 minute to 5 minutes) from the viewpoint of more excellent reaction efficiency.

The conditions for the light irradiation treatment is not particularly limited, and an ultraviolet irradiation method of generating and applying ultraviolet rays for photocuring is preferable. Ultraviolet lamps used for such method include a metal halide lamp, a high-pressure mercury lamp, a low-pressure mercury lamp, a pulsed xenon lamp, a xenon/mercury mixed lamp, a low-pressure germicidal lamp, and an electrodeless lamp. Among these ultraviolet lamps, a metal halide lamp or a high-pressure mercury lamp is preferable.

In addition, the irradiation conditions vary depending on the conditions of each lamp, but the irradiation exposure quantity may be typically in a range of 20 to 10000 mJ/cm² and preferably in a range of 100 to 3000 mJ/cm².

Moreover, the stepwise heat treatment or light irradiation may be performed while the conditions are changed within the range of the above-described preferred conditions. Further, for the purpose of controlling the temperature of the film on which wrinkles are unlikely to be generated, the temperature of a roll that comes into contact with the film when irradiated with UV rays may be controlled.

Hereinafter, a preferred embodiment of a composition for forming a hard coat layer used to form a hard coat layer will be described below.

[Composition (1) for Forming Hard Coat Layer]

In the present invention, a hard coat layer can he formed on the conductive layer by applying, drying, and curing a compound having an unsaturated double bond, a polymerization initiator, if necessary, light-transmitting particles, a fluorine-containing compound, or a silicone-based compound, or a composition containing a solvent directly or through another layer.

Hereinafter, each component included in the composition (1) for forming a hard coat layer will be described.

(Compound Having Unsaturated Double Bond)

The composition for forming a hard coat layer may contain a compound having an unsaturated double bond. The compound having an unsaturated double bond may function as a binder and it is preferable that the compound is a polyfunctional monomer having two or more polymerizable unsaturated groups. The polyfunctional monomer having two or more polymerizable unsaturated groups may function as a curing agent and is capable of improving the strength of a coated film and abrasion resistance. The number of polymerizable unsaturated groups is more preferably three or more. These monomers can be used in combination of a monofunctional or difunctional monomer with a tri- or higher functional monomer.

Examples of the compound having an unsaturated double bond include compounds having a polymerizable functional group such as a (meth)acryloyl group, a vinyl group, a styryl group, or an allyl group. Among these, acryloyl group and C(O)OCH═CH₂ are preferable. It is particularly preferable that a compound containing three or more (meth)acryloyl groups in a molecule, described below, is used. In addition, the term “(meth)acryloyl group” indicates an acryloyl group or a methacryloyl group. Similarly, the term “(meth)acrylic acid” described below indicates acrylic acid or methacrylic acid and the term “(meth)acrylate” indicates acrylate or methacrylate.

Specific examples of the compound having, a polymerizable unsaturated bond include (meth)acrylic acid diesters of alkylene glycol, (meth)acrylic acid diesters of polyoxyalkylene glycol, (meth)acrylic acid diesters of polyhydric alcohol, (meth)acrylic acid diesters of an ethylene oxide adduct or a propylene oxide adduct, epoxy (meth)acrylates, urethane (meth)acrylates, and polyester (meth)acrylates.

Among these, esters of polyhydric alcohol and (meth)acrylic acid are preferable. Examples thereof include 1,4-butanediol di(meth)acrylate, 1,6-hexanediol di(meth)acrylate, neopentyl glycol (meth)acrylate, ethylene glycol di(meth)acrylate, triethylene glycol di(meth)acrylate, pentaerythritol tetra(meth)acrylate, pentaerythritol tri(meth)acrylate, trimethylol propane tri(meth)acrylate, EO-modified trimethylol propane tri(meth)acrylate, PO-modified trimethylol propane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritoi penta(meth)acrylate, dipentaerythritol hexa(meth)acrylate, 1,2,3-cyclohexane tetramethacrylate, polyurethane polyacrylate, polyester polyacrylate, and caprolactone-modified tris(acryloxyethyl)isocyanurate.

Polyfunctional acrylate-based compounds having a (meth)acryloyl group are commercially available and examples thereof include NK ESTER A-TMMT (manufactured by Shin-Nakamura Chemical Co., Ltd.) and KAYARAD DPHA (manufactured by Nippon Kayaku Co., Ltd.). Polyfunctional monomers are described in paragraphs [0114] to [0122] of JP2009-98658A and the same applies to the present invention.

From the viewpoints of adhesiveness to the conductive layer, low curling, and fixing properties of fluorine-containing compounds or silicone-based compounds described below, it is preferable that the compound having an unsaturated double bond is a compound having a hydrogen-bonding substituent. The hydrogen-bonding substituent indicates a substituent obtained by covalently bonding an atom having high electronegativity such as nitrogen, oxygen, sulfur, or halogen to a hydrogen bond, and specific examples thereof include OH—, SH—, NH—, CHO—, and CHN—. Among these, urethane (meth)acrylates or (meth)acrylates having a hydroxyl group are preferable. Further, commercially available polyfunctional acrylate having a (meth)acrydoyl group can be used and examples thereof include NK OLIGO U4HA, NK ESTER A-TMM-3 (both manufactured by Shin-Nakamura Chemical Co., Ltd.), and KAYARAD PET-30 (manufactured by Nippon Kayaku Co., Ltd.).

From the viewpoint of imparting a sufficient degree of polymerization to provide hardness, the content of the compound having an unsaturated double bond in the composition for forming a hard coat layer is preferably 50% by mass or greater, more preferably in a range of 60% to 99% by mass, still more preferably in a range of 70% to 99% by mass, and particularly preferably in a range of 80% to 99% by mass with respect to the total solid content obtained by removing inorganic components from the composition for forming a hard coat layer.

It is preferable that a compound having cyclic aliphatic hydrocarbon and an unsaturated double bond in a molecule is used for the composition for forming a hard coat layer. When such a compound is used, low moisture permeability can be provided for a hard coat layer. In order to improve hard coat properties, it is more preferable to use a compound having, two or more cyclic aliphatic hydrocarbons and unsaturated double bonds in a molecule.

In a case where the composition for funning a hard coat layer contains a compound having cyclic aliphatic hydrocarbon and an unsaturated double bond in a molecule, the content of the compound, having cyclic aliphatic hydrocarbon and an unsaturated double bond in a molecule, in a compound having an unsaturated double bond in the composition for forming a hard coat layer is preferably in a range of 1% to 90% by mass, more preferably in a range of 2% to 80% by mass, and still more preferably in a range of 5% to 70% by mass.

In a case where the composition for forming a hard coat layer contains a compound having cyclic aliphatic hydrocarbon and an unsaturated double bond in a molecule, it is preferable that the composition further contains pinta- or higher functional (meth)acrylate.

In a case where the composition for forming a hard coat layer contains penta- or higher functional (meth)acrylate, the content of the penta- or higher functional (meth)acrylate in the compound having an unsaturated double bond in the composition for forming a hard coat layer is preferably in a range of 1% to 70% by mass, more preferably in a range of 2% to 60% by mass, and particularly preferably in a range of 5% to 50% by mass.

(Light-Transmitting Particles)

When a hard coat layer contains light-transmitting particles, it is possible to provide an uneven shape or inside haze for the surface of the hard coat layer.

Examples of light-transmitting particles which can be used for the hard coat layer include polymethyl methacrylate particles (refractive index of 1.49), crosslinked poly(acryl-styrene) copolymer particles (refractive index of 1.54), melamine resin particles (refractive index of 1.57), polycarbonate particles (refractive index of 1.57), polystyrene particles (refractive index of 1.60), crosslinked polystyrene particle (refractive index of 1.61), polyvinyl chloride particles (refractive index of 1.60), benzoguanamine-melamine formaldehyde particles (refractive index of 1.68), silica particles (refractive index of 1.46), alumina particles (refractive index of 1.63), zirconia particles, titanium particles, and particles having hallows or pores.

Among these, crosslinked ((meth)acrylate) particles, crosslinked poly(acryl-styrene) particles are preferably used, and the unevenness, surface haze, inside haze, and total haze suitable for the hard coat layer can be achieved by adjusting the refractive index of a binder in accordance with the refractive index of respective light-transmitting particles selected from these particles. The refractive index of the binder (light-transmitting resin) is preferably in a range of 1.45 to 1.70 and more preferably in a range of 1.48 to 1.65.

Further, a difference in refractive index between the light-transmitting particles and the binder in the hard coat layer (“refractive index of light-transmitting particles”−“refractive index of hard coat layer from which light-transmitting particles are removed”) is, as an absolute value, preferably less than 0.05, more preferably in a range of 0,001 to 0,030, and still more preferably in a range of 0.001 to 0.020. It is preferable that the difference in refractive index between the light-transmitting particles and the binder in the hard coat layer is set to be less than 0.05 because the refracting angle of light due to light-transmitting particles becomes small, scattered light does not spread to have a wide angle, and a deterioration action does not exist.

In order to obtain the above-described difference in refractive index between the particles and the binder, the refractive index of the light-transmitting particles or the refractive index of the binder may be adjusted.

According to a preferred first embodiment, it is preferable to use a combination of light-transmitting particles formed of a binder (the refractive index after curing is in a range of 1.50 to 1.53) having a tri- or higher functional (meth)acrylate monomer as a main component and a crosslinked poly(meth)acrylate-styrene copolymer having 50% to 100% by mass of acryl. The difference in refractive index between the light-transmitting particles and the binder is easily set to be less than 0.05 by adjusting the compositional ratio of an acryl component having a low refractive index and a styrene component having a high refractive index. The mass ratio between the acrylic component and the styrene component is preferably in a range of 50:50 to 100:0, more preferably in a range of 60:40 to 100:0, and most preferably in a range of 65:35 to 90:10. The refractive index of light-transmitting particles formed of a crosslinked poly(meth)acrylate-styrene copolymer is preferably in a range of 1.49 to 1.55, more preferably in a range of 1.50 to 1.54, and most preferably in a range of 1.51 to 1.53.

According to a preferred second embodiment, the refractive index of a binder formed of monomers and inorganic fine particles is adjusted and the difference in refractive index between the binder and light-transmitting particles of the related art is adjusted by combining inorganic fine particles having an average particle size of 1 to 100 nm with a binder having a tri- or higher functional (meth)acrylate monomer as a main component. Examples of inorganic particles include an oxide of at least one metal selected from silicon, zirconium, titanium, aluminum, indium, zinc, tin, and antimony and specific examples thereof include SiO₂, ZrO₂, Al₂O₃, In₂O₃, ZnO, SnO₂, Sb₂O₃, and ITO. Among these, SiO₂, ZrO₂, or Al₂O₃ is preferable. These inorganic particles can be mixed in a range of 1% to 90% by mass and preferably in a range of 5% to 65% by mass with respect to the total amount of monomers.

Here, the refractive index of the hard coat layer from which light-transmitting particles are removed can be quantitatively evaluated by directly measuring the value using an Abbe refractometer or measuring the spectral reflection spectrum or spectral ellipsometry. The refractive index of the light-transmitting particles is obtained by dispersing the equivalent amount of light-transmitting particles in a solvent whose refractive index is changed by changing the mixing ratio of two kinds of solvents having different refractive index to measure the turbidity and measuring the refractive index, of the solvent at the time when the turbidity becomes minimum using a Abbe refractometer.

The average particle diameter of light-transmitting particles is preferably in a range of 1.0 to 12 μm, more preferably in a range of 3.0 to 12 μm, and still more preferably in a range of 4.0 to 10.0 μm, and most preferably in a range of 4.5 to 8 μm. When the difference in refractive index and the grain size are set to be in the above-described range, the scattering angle distribution of light does not spread to a wide angle and blurred characters and contrast deterioration of a display are unlikely to occur. From the viewpoints that the film thickness of a layer to be added does not need to be increased and a problem of curling or an increase in cost is unlikely to occur, the average particle diameter thereof is preferably 12 μm or less. It is preferable that the average particle diameter thereof is in the above-described range from the viewpoints that the coating amount at the time of application is suppressed, the coated surface is rapidly dried, and planar defects such as uneven drying are unlikely to be generated.

Any measurement method can be used as a method of measuring the average particle diameter of light-transmitting particles as long as the method is for measuring the average particle diameter of particles, but, preferably, the average particle diameter thereof can be obtained by observing particles using a transmission electron microscope (magnification of 500000 to 2000000 times), observing 100 particles, and calculating the average value.

The shape of the light-transmitting particles is not particularly limited, but light-transmitting particles having different shapes such as deformed particles (for example, non-spherical particles) may be used in combination in place of spherical particles. Particularly when the short axis of non-spherical particles is aligned to the normal direction of the hard coat layer, particles having small particle diameters compared to the spherical particles can be used.

It is preferable light-transmitting particles are blended into the hard coat layer such that the content thereof is in a range of 0.1% to 40% by mass with respect to the total solid content of the hard coat layer. The content thereof is more preferably in a range of 1% to 30% by mass and still more preferably in a range of 1% to 20% by mass. When the blending ratio of light-transmitting particles is set to be in the above-described range, the inside haze can be controlled to be in the preferable range.

Moreover, the amount of light-transmitting particles to be applied is preferably in a range of 10 to 2500 mg/m², more preferably in a range of 30 to 2000 mg/m², and still more preferably in a range of 100 to 1500 mg/m².

Examples of the method of producing light-transmitting particles include a suspension polymerization method, an emulsion polymerization method, a soap-free emulsion polymerization method, a dispersion polymerization method, and a seed polymerization method, and light-transmitting particles may be produced any of these methods. These production methods can be referred to methods described in, for example, “Experimental Method of Polymer Synthesis” (co-edited by Takayuki Otsu and Kinoshita Masayoshi, published by KAGAKUDOJIN), p. 130, 146, and 147; “Synthetic Polymer” Vol. 1, p. 246 to 290; “Synthetic Polymer” Vol. 3, p. 1 to 108; JP2543503B; JP3508304B; JP2746275B; JP3521560B; JP3580320B; JP1998-1561A (JP-H10-1561A), JP1995-2908A (JP-H07-2908A), JP1993-297506A (JP-H05-297506A), and JP2002-145919A.

From, the viewpoints of controlling the haze value and diffusibility and evenness of the coated surface, monodisperse particles are preferable as the particle size distribution of light-transmitting particles. A CV value representing uniformity of particle diameters is preferably 15% or less, more preferably 13% or less, and still more preferably 10% or less. Further, in a case where a particle having a particle diameter larger than the average particle diameter by 20% or greater is defined as a coarse particle, the percentage of the coarse particles is preferably 1% or less, more preferably 0.1% or less, and still more preferably 0.01% or less. Particles having such particle size distribution are obtained by classification as useful means after preparation or a synthetic reaction. When the number of times of classifications is increased and the degree thereof is made to be high, particles having desired distribution can be obtained.

It is preferable that an air classification method, a centrifugal classification method, a filtration classification method, or an electrostatic classification method is used for the above-described classification.

(Photopolymerization Initiator)

It is preferable that the composition for forming a hard coat layer contains a photopolymerization initiator.

From the viewpoints that the amount of a photopolymerization initiator is sufficiently large enough to polymerize a polymerizable compound contained in the composition for forming a hard coat layer and the amount thereof is set to be sufficiently low such that the start point is not extremely increased, the content of the photopolymerization initiator in the composition for forming a hard coat layer is preferably in a range of 0.5% to 8% by mass and more preferably in a range of 1% to 5% by mass with respect to the total solid content in the composition for forming a hard coat layer.

(Ultraviolet Absorbing Agent)

The conductive film is used for a member or the like of a display device provided with a touch panel. From the viewpoint of preventing deterioration of liquid crystals or the like, ultraviolet absorbing properties can he provided for the conductive film by allowing the hard coat layer to contain an Ultraviolet absorbing agent within the range that does not inhibit UV curing.

(Solvent)

The composition for forming a hard coat layer may contain a solvent. As the solvent, various solvents can be used in consideration of solubility of a monomer, dispersibility of light-transmitting particles, and drying properties during application. Examples of organic solvents include dibutyl ether, dimethoxy ethane, diethoxy ethane, propylene oxide, 1,4-dioxane, 1,3-dioxolane, 1,3,5-trioxane, tetrahydrofuran, anisole, phenetole, dimethyl carbonate, methyl ethyl carbonate, diethyl carbonate, acetone, methyl ethyl ketone (MEK), diethyl ketone, dipropyl ketone, diisobutyl ketone, cyclopentanone, cyclohexanone, methyl cyclohexanone, ethyl formate, propyl formate, pentyl formate, methyl acetate, ethyl acetate, propyl acetate, methyl propionate, ethyl propionate, γ-butyrolactone, methyl 2-methoxy acetate, methyl 2-ethoxy acetate, ethyl 2-ethoxy acetate, ethyl 2-ethoxy propionate, 2-methoxyethanol, 2-propoxyethanol, 2-buthoxyethanol, 1,2-diacetoxy acetone, acetyl acetone, diacetone alcohol, methyl acetoacetate, ethyl acetoacetate, methyl alcohol, ethyl alcohol, isopropyl alcohol, n-butyl alcohol, cyclohexyl alcohol, isobutyl acetate, methyl isobutyl ketone (MIBK), 2-octanone, 2-pentanone, 2-hexanone, ethylene glycol ethyl ether, ethylene glycol isopropyl ether, ethylene glycol butyl ether, propylene glycol methyl ether, ethyl carbitol, butyl carbitol, hexane, heptane, octane, cyclohexane, methyl cyclohexane, ethyl cyclohexane, benzene, toluene, and xylem, and organic solvents can he used alone or in combination of two or more kinds thereof.

A solvent is used such that the concentration of the solid content in the composition for forming a hard coat layer is set to be preferably in a range of 20% to 80% by mass, more preferably in a range of 30% to 75% by mass, and still more preferably in a range of 40% to 70% by mass.

[Composition (2) for Forming Hard Coat Layer]

Next, a composition for forming an (antistatic) hard coat layer sed for an antistatic antirefl ection film will be described.

Hereinafter, various components contained in the composition (2) for forming a hard coat layer be described in detail,

(Compound Having Quaternary Ammonium Base)

The composition for forming a hard coat layer contains a compound having a quaternary ammonium base.

As the compound having a quaternary ammonium base, both of a low molecular type compound and a high molecular type compound can be used, but a high molecular type cationic compound is more preferably used from the viewpoint that the high molecular type cationic compound does not have a variation in antistatic properties due to bleed out.

The high molecular type cationic compound having a quaternary ammonium base can be selected from known compounds for use, but a quaternary ammonium base-containing polymer is preferable and a polymer having at least one structural unit represented by any of the following Formulae (I) to (III) is preferable, from the viewpoint of excellent ion conductivity.

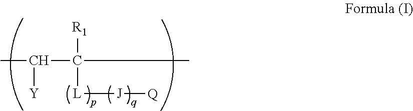

In Formula (I), R₁ represents a hydrogen atom, an alkyl up, a halogen atom, or CH₂COO⁻M⁺. Y represents a hydrogen atom or COO—M+. M+ represents a proton or a cation. L represents —CONH—, —COO—, —CO—, or —O—. J represents an alkylene group, an arylene group, or a group formed by combining these. Q represents a group selected from the following group A.

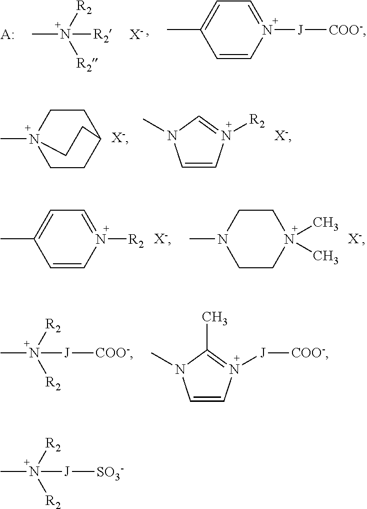

In the formulae, R₂, R₂′, and R₂″ each independently represent an alkyl group. J represents an alkylene group, an arylene group, or a group formed by combining these. X⁻ represents an anion. p and q each independently represent 0 or 1.

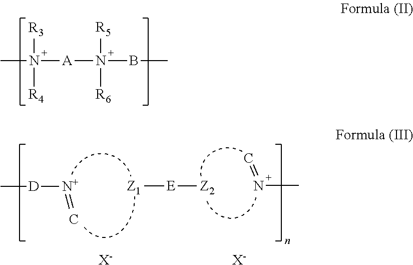

In Formula (II), R₃, R₄, R₅, and R₆ each independently represent an alkyl group. Further, R₃ and R₄, and R₅ and R₆ may be bonded to each other to respectively form a nitrogen-containing heterocycle.

A and B in Formula (II) and D in Formula (III) each independently represent an alkylene group, an arylene group, an alkenylene group, an arylene-alkylene group, —R₇COR₈—, —R₉COOR₁₀OCOR₁₁—, —R₁₃OCR₁₃COOR₁₄—, —R₁₅—(OR₁₆)m-, R₁₇CONHR₁₈NHCOR₁₉—, —R₂₀OCONHR₂₁NHCOR₂₂—, or —R₂₃NHCONHR₂₄NHCONHR₂₅—.

E in Formula (III) represents a single bond, an alkylene group, an arylene group, an alkenylene group, an arylene-alkylene group, —R₇COR₈—, —R₉COOR₁₀OCOR₁₁—, —R₁₂OCR₁₃COOR₁₄—, —R₁₅—(OR₁₆))m-, R₁₇CONHR₁₈NHCOR₁₉—, —R₂₀OCONHR₂₁NHCOR₂₂—, —R₂₃NHCONHR₂₄NHCONHR₂₅—, or —NHCOR₂₆CONH—. R₇, R₈, R₉, R₁₁, R₁₂, R₁₄, R₁₅, R¹⁶, R₁₇, R₁₉, R₂₀, R₂₂, R₂₃, R₂₅, and R₂₆ represent an alkylene group. R₁₀, R₁₃, R₁₈, R₂₁, and R₂₄ each independently represent a linking group selected from an alkylene group, an alkenylene group, an arylene group, an arylene-alkylene group, and an alkylene-arylene group. m represents a positive integer of 1 to 4.

X— represents an anion.

Z₁ and Z₂ represent a nonmetallic atomic group required for forming a 5- or 6-membered ring together with a —N═C— group and may be linked to E in the form of a quaternary salt which becomes ≡N⁺[X⁻]—.

n represents an integer of 5 to 300.

Groups of Formulae (I) to (III) will be described.

Examples of a halogen atom include a chlorine atom and a bromine atom. Among these, a chlorine atom is preferable.

As an alkyl group, a branched or linear alkyl group having 1 to 4 carbon atoms is preferable and a methyl group, an ethyl group, or a propyl group is more preferable.

As an alkylene group, an alkylene group having 1 to 12 carbon atoms is preferable and a methylene group, an ethylene group, or a propylene group is more preferable, and an ethylene group is particularly preferable.

As an arylene group, an arylene group having 6 to 15 carbon atoms is preferable, a phenylene group, a diphenylene group, a phenyl dimethylene group, or a naphthylene group is more preferable and a phenyl methylene group is particularly preferable. These groups may include a substituent.

As an alkenylene group, an alkenylene group having 2 to 10 carbon atoms is preferable.. As arylene-alkylene group, an arylene-alkylene group having 6 to 12 carbon atoms is preferable. These groups may include a substituent.

Examples of the substituent which may be substituted with each group include a methyl group, an ethyl group, and a propyl group.

In Formula (I), it is preferable that R1 represents a hydrogen atom or a methyl group.

It is preferable that Y represents a hydrogen atom.

It is preferable that L represents —COO—.

It is preferable that J represents a phenylmethylene group, a methylene group, an ethylene group, or a propylene group.

Q represents a group represented by the following Formula (VI) and R₂, R₂′, and R₂″ each represent a methyl group.

X— represents a halogen ion, a sulfonate anion, or a carboxylate anion. Among these, a halogen ion is preferable and a chlorine ion is more preferable.

It is preferable that p and q represent 0 or 1 and more preferable that p and q represent 1.

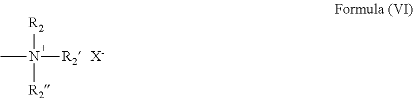

In Formula (II), R₃, R₄, R₅, and R₆ represent preferably a substituted or unsubstituted alkyl group having 1 to 4 carbon atoms, more preferably a methyl group or an ethyl group, and particularly preferably a methyl group.

A and B in Formula (II) and D in Formula (III) each independently represent preferably a substituted or unsubstituted alkylene group having 2 to 10 carbon atoms, an arylene group, an alkenylene group, or an arylene-alkylene group and more preferably a phenyldimethylene group.

X— represents a halogen ion, a sulfonate anion, or a carboxylate anion. Among these, a halogen ion is preferable and a chlorine ion is more preferable.

It is preferable that E represents a single bond, an alkylene group, an arylene group, an alkenylene group, or an arylene-alkylene group.

As the 5- or 6-membered ring formed by Z₁ and Z₂ together with a —N═C— group, a diazoniabicyclooctane ring or the like may be exemplified.

Hereinafter, specific examples of the compound having a structural unit represented by any of Formulae (I) to (III) will be described, but the present invention is not limited thereto. In the subscripts (m, x, y, r, and actual numerical values) of the following specific examples, in represents the number of repeating units of each unit and x, y, and r represent the molar ratio of each unit.

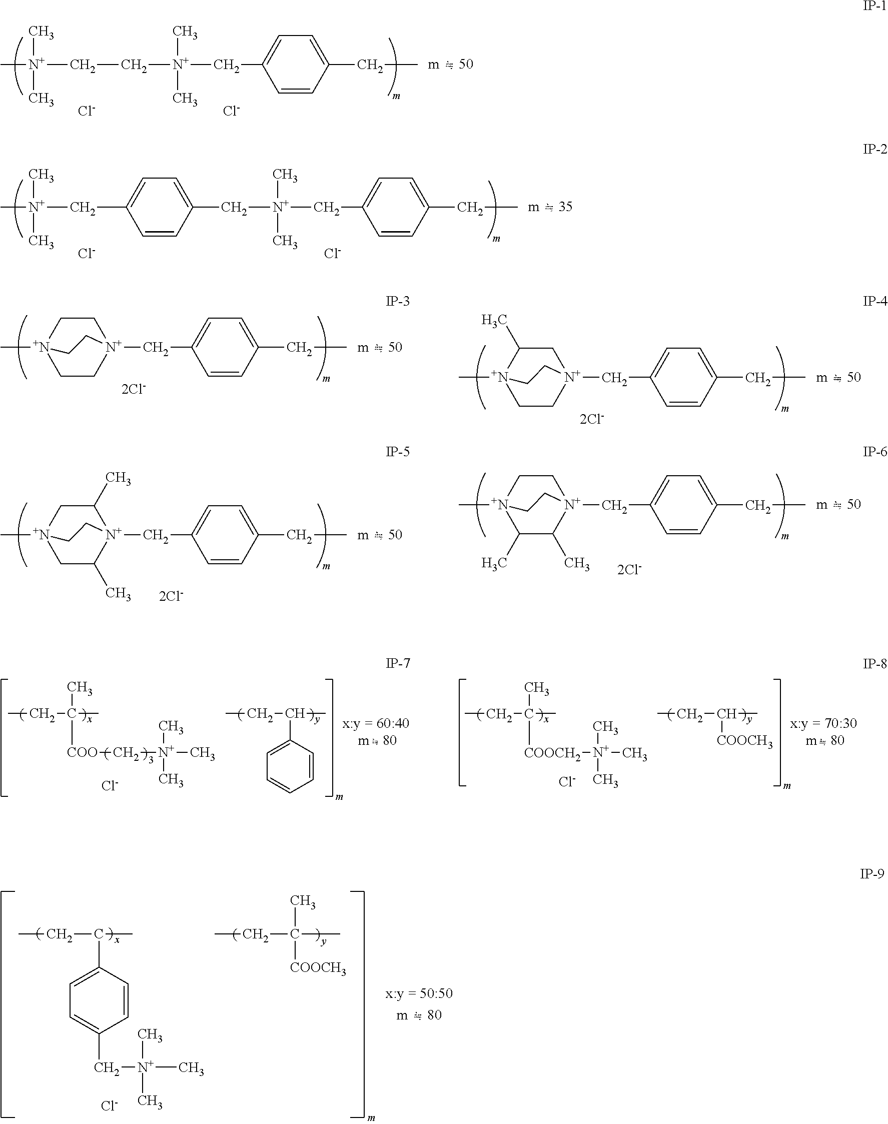

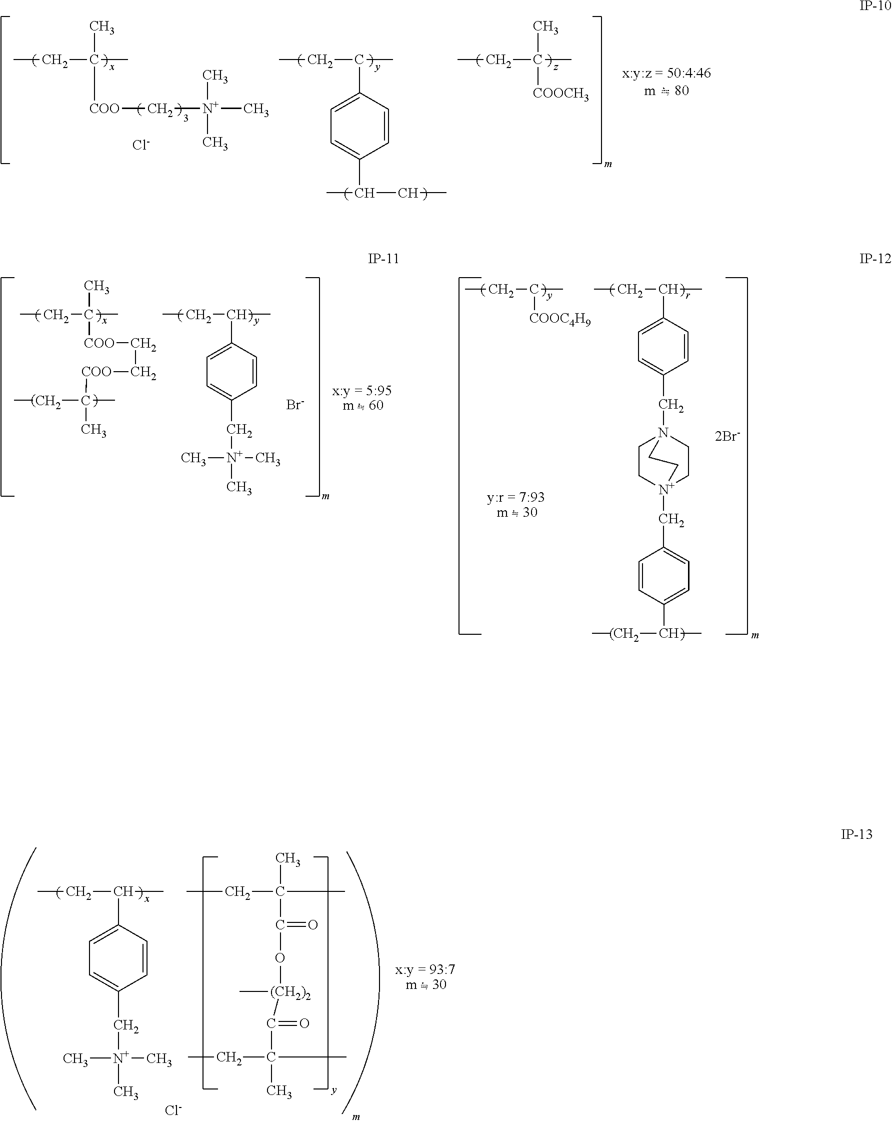

The conductive compounds exemplified in the above may be used alone or in combination of two or more compounds. Further, an antistatic compound having a polymerizable group in a molecule of an antistatic agent is more preferable because scratch resistance (film hardness) of an antistatic layer can be also improved.

As the compound having a quaternary ammonium base, commercially available products can be used. Examples thereof include “LIGHT ESTER DO-100” (trade name, manufactured by KYOEISHA CHEMICAL Co., Ltd.), “LIODURAS LAS-1211” (trade name, manufactured by TOYO INK CO., LTD.), “SHIKOU UV-AS-102” (trade name, manufactured by Nippon Synthetic Chemical Industry Co., Ltd.), and “NK OLIGO U-601 and 201” (manufactured by Shin-Nakamura Chemical Co., Ltd.).

A quaternary ammonium base-containing polymer may include a structural unit (repeating unit) other than the structural units (ionic structural units) represented by the above-described Formulae (I) to (III). When a compound having a quaternary ammonium base includes a structural unit other than ionic structural units, solubility in a solvent during preparation of a composition and compatibility with a compound having an unsaturated double bond or a photopolymerization initiator can be improved.

The polymerizable compound used to introduce a structural unit other than structural units represented by the above-described Formulae (I) to (III) is not particularly limited, and examples thereof include polymerizable compounds selected from a compound having an alkylene oxide chain such as polyethylene glycol mono(meth)acrylate, polypropylene glycol mono(meth)acrylate, polybutylene glycol mono(meth)acrylate, poly(ethylene glycol-propylene glycol) mono(meth)acrylate, poly(ethylene glycol-tetramethylene glycol) mono(meth)acrylate, poly(propylene glycol-tetramethylene glycol) mono(meth)acrylate, polyethylene glycol mono(meth)acrylate monomethyl ether, polyethylene glycol mono(meth)acrylate monobutyl ether, polyethylene glycol mono(meth)acrylate monooctyl ether, polyethylene glycol mono(meth)acrylate monobenzyl ether, polyethylene glycol mono(meth)acrylate monophenyl ether, polyethylene glycol mono(meth)acrylate monodecyl ether, polyethylene glycol mono(meth)acrylate monododecyl ether, polyethylene glycol mono(meth)acrylate nionotetradecyl ether, polyethylene glycol mono(meth)acrylate monohexadecyl ether, polyethylene glycol mono(meth)acrylate monooctadecyl ether, poly(ethylene glycol-propylene glycol) mono(meth)acrylate octyl ether, poly(ethylene glycol-propylene glycol) mono(meth)acrylate octadecyl ether, or poly(ethylene glycol-propylene glycol) mono(meth)acrylate nonyl phenyl ether; alkyl (meth)acrylate such as methyl (meth)acrylate, ethyl (meth)acrylate, propyl (meth)acrylate, butyl (meth)acrylate, 2-ethylhexyl (meth)acrylate, dodecyl (meth)acrylate, or octadecyl (meth)acrylate; hydroxyalkyl (meth)acrylate such as hydroxyethyl (meth)acrylate, bydroxypropyl (meth)acrylate, or hydroxybutyl (meth)acrylate; various (meth)acrylates such as benzyl (meth)acrylate, cyclohexyl (meth)acrylate, isobornyl (meth)acrylate, dicyclopentenyl (meth)acrylate, dicyclopentenyloxyethyl (meth)acrylate, ethoxyethyl (meth)acrylate, ethyricarbitol (meth)acrylate, butoxyethyl (meth)acrylate, cyanoethyl (meth)acrylate, and glycidyl (meth)acrylate; styrene; and methylstyrene; and combinations of these.

From the viewpoints that the amount of the compound having a quaternary ammonium base in the composition for forming a hard coat layer is sufficient enough to provide antistatic properties and the film hardness is unlikely to be impaired, the content thereof is preferably in a range of 1% to 30% by mass, more preferably in a range of 3% to 20% by mass, and still more preferably in a range of 5% to 15% by mass with respect to the total solid content in the composition for forming a hard coat layer.

(Compound Having Unsaturated Double Bond)

The composition for forming a hard coat layer may contain a compound having an unsaturated double bond. The compound having an unsaturated double bond has the same definition as the compound described in the above-described section of “Composition (1) for forming hard coat layer”.

From the viewpoint of imparting a polymerization rate sufficiently to provide the hardness or the like, the content of the compound having an unsaturated double bond in the composition for forming a hard coat layer is preferably in a range of 40% to 98% by mass and. more preferably in a range of 60% to 95% by mass with respect to the total solid content in the composition for forming a hard coat layer.

(Photopolymerization Initiator)

The composition for forming a hard coat layer may contain a photopolymerization initiator.

Examples of the photopolymerization initiator include acetophenones, benzoins, benzophenones, phosphine oxides, ketals, anthraquinones, thioxanthones, azo compounds, peroxides, 2,3-dialkyklione compounds, disulfide compounds, fluoroamine compounds, aromatic sulfoniums, lophine dimers, onium salts, borate salts, active esters, active halogens, inorganic complexes, and coumarins. The specific examples, preferred embodiments, and commercially available products of the photopolymerization initiator are the same as those described in paragraphs [0133] to [0151] of JP2009-098658A, and those can be also suitably used in the present invention.

Various examples thereof are also described in “Latest UV Curing Technology” {Technical Information institute Co., Ltd.} (1991), p. 159 and “UV Curing System” written by Kiyoshi Kato (1989, published by Sogo Gijutsu Center Co., Ltd.), p. 65 to 148 and the examples can be used in the present invention.

From the viewpoints that the amount of a photopolymerization initiator is sufficiently large enough to polymerize a polymerizable compound contained in the composition for forming a hard coat layer and the amount thereof is set to be sufficiently low such that the start point is not extremely increased, the content of the photopolymerization initiator in the composition for forming a hard coat layer is preferably in a range of 0.5% to 8% by mass and more preferably in a range of 1% to 5% by mass with respect to the total solid content in the composition for forming a hard coat layer.

(Solvent)

The composition for forming a hard coat layer may contain various organic solvents.

From the viewpoint of obtaining compatibility with an ion-conductive compound, it is preferable that the composition of the present invention contains a hydrophilic solvent. Examples of the hydrophilic solvent include alcohol-based solvents, carbonate-based solvents, and ester-based solvents. Specific examples thereof include methanol, ethanol, isopropanol, n-butyl alcohol, cyclohexyl alcohol, 2-ethyl-1-hexanol, 2-methyl-1-hexanol, 2-methoxyethanol, 2-propoxyethanol, 2-butoxyethanol, diacetonc alcohol, dimethyl carbonate, diethyl carbonate, diisopropyl carbonate, methyl ethyl carbonate, methyl n-propyl carbonate, ethyl formate, propyl formate, pentyl formate, methyl acetate, ethyl acetate, propyl acetate, methyl propionate, ethyl propionate, ethyl 2-ethoxy propionate, methyl acetoacetate, ethyl acetoacetate, methyl 2-methoxy acetate, methyl 2-ethoxy acetate, ethyl 2-ethoxy acetate, acetone, 1,2-diacetoxy acetone, and acetyl acetone, and these solvents can be used alone or in combination of two or more kinds thereof.

Further, solvents other than the above-described solvents may be used. Examples thereof include ether-based solvents, ketone-based solvents, aliphatic hydrocarbon-based solvents, and aromatic hydrocarbon-based solvents. Specific examples thereof include dibutyl ether, dimethoxy ethane, diethoxy ethane, propylene oxide, 1,4-dioxane, 1,3-dioxotane, 1,3,5-trioxane, tetrahydrofuran, anisole, phenetole, methyl ethyl ketone (MEK), diethyl ketone, dipropyl ketone, diisobutyl ketone, cyclopentanone, cyclohexanone, methyl cyclohexanone, methyl isobutyl ketone, 2-octane, 2-pentanone, 2-hexanone, ethylene glycol ethyl ether, ethylene glycol isopropyl ether, ethylene glycol butyl ether, propylene glycol methyl ether, ethyl carbitol, butyl carbitol, hexane, heptane, octane, cyclohexane, methyl cyclohexane, ethyl cyclohexane, benzene, toluene, and xylene, and these solvents can be used alone or in combination of two or more kinds thereof.

A solvent is used such that the concentration of the solid content in the composition for forming a hard coat layer is preferably in a range of 20% to 80% by mass, more preferably in a range of 30% to 75% by mass, and most preferably in a range of 40% to 70% by mass.

(Surfactant)

Various surfactants may be suitably used for the composition for forming a hard coat layer. Typically, a surfactant suppresses film thickness irregularity caused by uneven drying due to local distribution of dry air and improves surface unevenness of an antistatic layer or cissing a coated product. In addition, preferably, excellent conductivity can be more stably expressed in some cases by improving the dispersibility of an antistatic compound.

As a surfactant, specifically, a fluorine-based surfactant or a silicone-based surfactant is preferable. Further, it is preferable that a surfactant is an oligomer or a polymer rather than a low-molecular weight compound.

When a surfactant is added, since the surfactant is rapidly moved to the surface of a coated liquid film and unevenly distributed and the surfactant is unevenly distributed on the surface as it is after the film is dried, the surface energy of the hard coat layer to which the surfactant is added is decreased due to the surfactant. From the viewpoint of preventing film thickness irregularity, cissing, and unevenness of the hard coat layer, it is preferable that the surface energy of the film is low.

Particularly from the viewpoint of preventing point defects caused by cissing and unevenness, a fluoroaliphatic group-containing copolymer including a repeating unit derived from a monomer containing a fluoroaliphatic group represented by the following Formula (F1) and a repeating unit derived from a monomer which does not contain a fluoroaliphatic group represented by the following Formula (F2) is preferable as the fluorine-based surfactant.

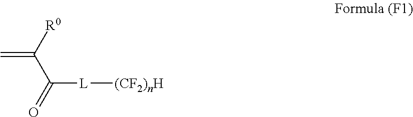

(In the formula, R⁰ represents a hydrogen atom, a halogen atom, or a methyl group. L represents a divalent linking group. n represents an integer of 1 to 18.)

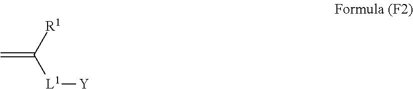

(In the formula, R¹ represents a hydrogen atom, a halogen atom, or a methyl group. L¹ represents a divalent linking group, Y represents a linear, branched, or cyclic alkyl group which may have a substituent and has 1 to 20 carbon atoms or an aromatic group which may have a substituent.)

It is preferable that a monomer containing a fluoroaliphatic group represented by Formula (F1) is a monomer containing a fluoroaliphatic group represented by the following Formula (F1-1)

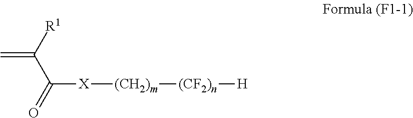

(In the formula, R¹ represents a hydrogen atom, a halogen atom, or a methyl group. X represents an oxygen atom, a sulfur atom, or —N(R²)—. m represents an integer of 1 to 6. n represents an integer of 1 to 18. R² represents a hydrogen atom or an alkyl group which may have a substituent and has 1 to 8 carbon atoms.)

Preferred embodiments and specific examples of the fluoroaliphatic group-containing copolymer are described in paragraphs [00231 ] to [0080 ] of JP2007-102206A and the same applies to the present invention.

Preferred examples of the silicone-based surfactant include surfactants which include plural dimethylsilyloxy units as repeating units and have substituents at the terminal and/or side chain of the compound chain. The compound chain having dimethylsilyloxy as a repeating unit may include a structural unit other than dimethylsilyloxy. The substituents may he the same as or different from each other and it is preferable that a plurality of substituents are present. Preferred examples of the substituents include groups having a polyether group, an alkyl group, an aryl group, an aryloxy group, a cinnamoyl group, an oxetanyl group, a fluoroalkyl group, or a polyoxyalkylene group.

The molecular weight is not particularly limited, but is preferably 100000 or less and more preferably 50000 or less, particularly preferably in a range of 1000 to 30000, and most preferably in a range of 1000 to 20000.

Preferred examples of the silicone-based compound include “X-22-174DX”, “X-22-2426”, “X22-164C”, “X-22-176D” (all trade names, manufactured by Shin-Etsu Chemical Co., Ltd.); “FM-7725”, “FM-5521”, “FM-6621”, (all trade names, manufactured by CHISSO CORPORATION); “DMS-U22”, “RMS-033” (all trade names, manuthetured by Gelest, Inc.); “SH200”, “DC11PA”, “ST80PA:, “L7604”, “FZ-2105”, “L-7604”, “Y-7006”, SS-2801″ (all trade names, manufactured by Dow Corning Toray Co., Ltd.); and “TSF400” (trade name, manufactured by Momentive Performance Materials Inc.), but the examples are not limited to these.

The content of the surfactant is preferably in a range of 0.01% to 0.5% by mass and more preferably in a range of 0.01% to 0.3% by mass with respect to the total solid content of the composition for forming a hard coat layer.

Moreover, a photosensitive composition described in JP2012-78528A may be used as the composition for forming a hard coag layer in place of the composition (1) for forming a hard coat layer and the composition (2) for forming a hard coat layer described above.

<Conductive Film and Applications Thereof>

The conductive film of the present invention includes the support, the conductive layer, and the hard coat layer described above.

The sheet resistance value of the conductive film is not particularly limited, but is preferably in a range of 10 to 150 Ω/□ and more preferably in a range of 10 to 100 Ω/□, from the viewpoint of more excellent conductivity.

The sheet resistance value is a value measured using Loresta-GP (MCP-T600) (Mitsubishi Chemical Holdings Corporation) in conformity with JIS K 7194 according to a four probe method.

In addition, as described above, it is preferable that wrinkles are not present on the conductive film. Practically, this is not problematic as long as wrinkles cannot be recognized when the conductive film after a hard coat layer is formed is visually observed in an environment of transmitted light and reflected light. It is difficult to quantitatively define the range in which wrinkles are not practically problematic, but a method of measuring the thickness of the front film or the rear film using a contactless type laser displacement meter (LK-G5000, manufactured by Keyence Corporation) may be used. That is, both of the front film and the rear film are separately measured at a length of 100 mm or greater in the width direction of the conductive film from an arbitrary fixed point and then an average period of unevenness (for example, the distance between concave portions) is acquired. The period is preferably 100 μm or less, more preferably 50 μm or less, and most preferably 10 μm or less.

The conductive film can be used for various applications and, for example, may be used for a touch panel (alternatively, for a touch panel sensor) or the like.

[Polarizing Plate]

A polarizing plate of the present invention includes the above-described conductive film of the present invention and a polarizer.

Here, a surface bonded to the polarizer on the above-described conductive film is not particularly limited and may be on the conductive layer side or the support side. Further, for the purpose of controlling the surface energy suitable for adhesion, the polarizer may adhere to the surface after a known surface treatment such as a corona treatment is performed. For example, in a case where the polarizer adheres to the support side, the surface of cellulose acylate is subjected to a saponification treatment using cellulose acylate as the support and then the polarizer may adhere to the support.

Hereinafter, the polarizer to be used will be described in detail.

The polarizer may be a member having a function of converting light into specific linearly polarized light and an absorptive type polarizer or a reflective type polarizer can be used.

Examples of the absorptive type polarizer include an iodine-based polarizer, a dye-based polarizer using a dichroic dye, and a polyene-based polarizer. A coating type polarizer and a stretching type polarizer may be exemplified as the iodine-based polarizer and the dye-based polarizer and both can be used, but a polarizer prepared by adsorbing iodine or a dichroic dye to polyvinyl alcohol to be stretched is preferable.

Further, examples of a method of obtaining a polarizer by performing stretching and dyeing in a state of a laminated film having a polyvinyl alcohol layer formed on a base include methods described in JP5048120B, JP5143918B, JP4691205B, JP4751481B, and JP4751486B, and a known technique related to these polarizers can be preferably used.

Examples of the reflective type polarizer include a polarizer formed by laminating a thin film having a different film birefringence, a wire grid type polarizer, and polarizer obtained by combining, a cholesteric liquid crystal having a selective reflection range with a quarter wavelength plate.

Among these, from the viewpoint of more excellent adhesiveness to the conductive layer described below, a polarizer including a polyvinyl alcohol-based resin (particularly, at least one selected from the group consisting of polyvinyl alcohol and an ethylene-vinyl alcohol copolymer) is preferable.

The thickness of the polarizer is not particularly but is preferably 35 μm or less, more preferably in a range of 3 to 30 μm and still more preferably in a range of 5 to 30 μm, from the viewpoint of reducing the thickness of a display device.

In addition, the thickness thereof is an average value obtained by measuring the thicknesses of arbitrary 10 points of the polarizer and arithmetically averaging the values.

(Application for Touch Panel)

Hereinafter, a preferred embodiment of a case where the conductive film is applied to a touch panel will be described in detail.

The above-described conductive film can be suitably used for a touch panel (preferably, a capacitance touch panel) More specifically, the conductive film can be used as a member constituting a touch panel and a conductive layer can he suitably used for a detection electrode (sensor electrode) for sensing a change in capacitance or a lead-out wiring (peripheral wiring) used for applying a voltage to a detection electrode.

[Display Device Provided with Touch Panel]

A display device provided with a touch panel of the present invention includes the above-described conductive film of the present invention.

### First Embodiment

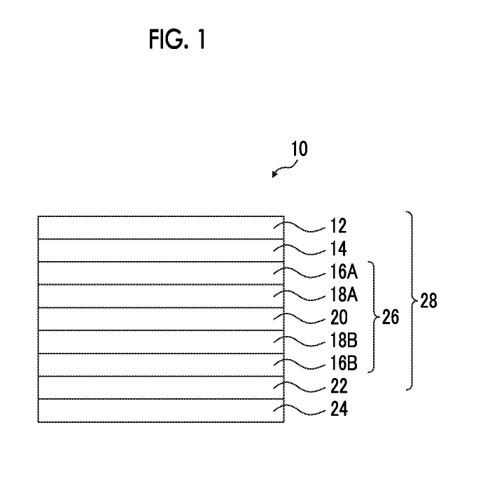

Hereinafter, a first embodiment of a display device provided with a touch panel to which the conductive film of the present invention is applied will be described with reference to FIG. 1. FIG. 1 is a sectional view schematically illustrating an example of a display device provided with a touch panel of the present invention. Further, FIG. 1 is a view schematically illustrated for ease of understanding of a layer structure of the display device provided with a touch panel and does not precisely illustrates the disposition of each layer.

As illustrated in FIG. 1, a display device 10 provided with a touch panel of the present invention includes a protective substrate 12, an upper pressure sensitive adhesive layer 14, a first hard coat layer 16A, a first conductive layer 18A for a touch panel, a support 20, a second conductive layer 18B for a touch panel, a second hard coat layer 16B, a lower pressure sensitive adhesive layer 22, and a display device 24 in this order. The first hard coat layer 16A, the first conductive layer 18A for a touch panel, the support 20, and the second conductive layer 18B for a touch panel, and the second hard coat layer 16B constitute a conductive film 26. Further, the protective substrate 12, the upper pressure sensitive adhesive layer 14, the conductive film 26, and the lower pressure sensitive adhesive layer 22 constitute a capacitance touch panel 28. As described below, as the first conductive layer 18A for a touch panel and the second conductive layer 18B for a touch panel, the above-described conductive layer containing fullerene functionalized carbon nanotubes may be exemplified. That is, the conductive film 26 corresponds to the conductive film of the present invention.

Moreover, when a finger approaches and touches the surface (touch surface) of the protective substrate 12 in the display device 10 provided with a touch panel, the capacitance between the finger and the detection electrode in the conductive film 26 is changed. Here, a position detection driver illustrated) constantly detects a change in capacitance between a finger and a detection electrode. When a change in capacitance of a predetermined value or greater is detected, the position detection driver detects the position at which the change in capacitance is detected as an input position. In this manner, the display device 10 provided with a touch panel is capable of detecting an input position.

Hereinafter, each member included in a touch panel will be described in detail. First, the conductive film 26 will be described in detail.

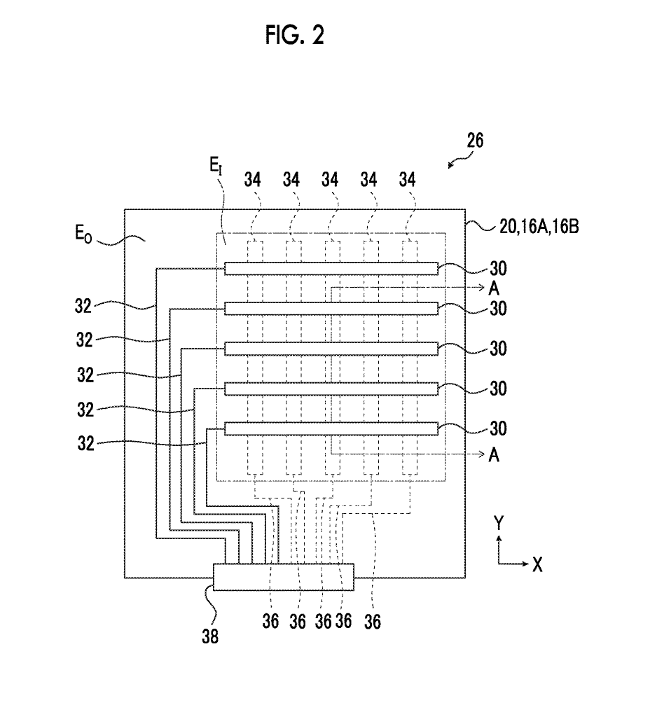

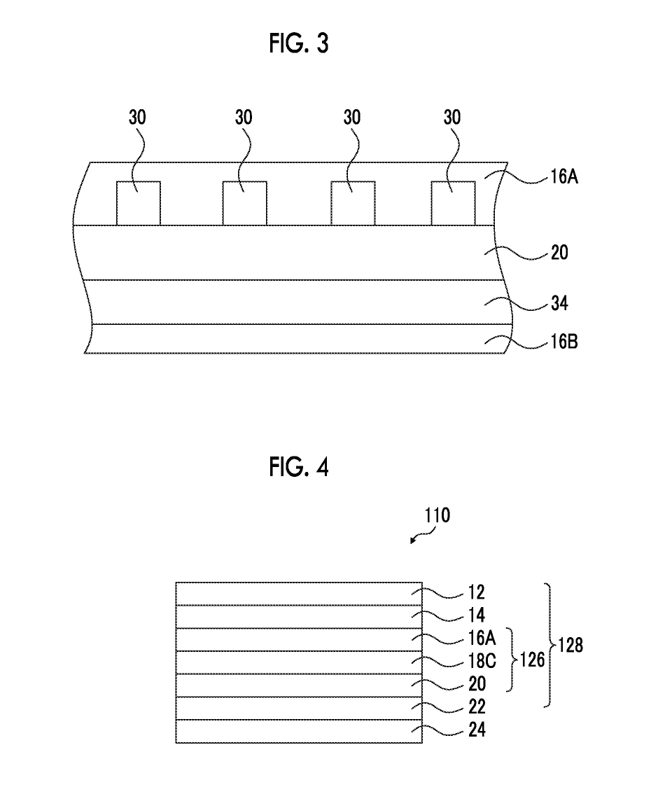

FIG. 2 is a plan view illustrating the conductive film 26. FIG. 3 is a sectional view taken along the line A-A Of FIG. 2.

The conductive film 26 includes the support 20, the first conductive layer 18A for a touch panel disposed on one main surface (on the front surface) of the support 20, the first hard coat layer 16A, the second conductive layer 18B for a touch panel disposed on the other main surface (on the back surface) of the support 20, the second hard coat layer 16B, and a flexible printed wiring board 38 and functions as a touch panel sensor. The first conductive layer 18A for a touch panel includes a first detection electrode 30 and a first lead-out wiring 32 and the second conductive layer 18B for a touch panel includes a second detection electrode 34 and a second lead-out wiring 36.

The first detection electrode 30, the first lead-out wiring 32, the second detection electrode 34, and the second lead-out wiring 36 contain fullerene functionalized carbon nanotubes. That is, the first detection electrode 30, the first lead-out wiring 32, the second detection electrode 34, and the second lead-out wiring 36 correspond to the above-described conductive layer. Further, the present invention is not limited to this embodiment, and only the first detection electrode 30 and the second detection electrode 34 may be the conductive layer containing fullerene functionalized carbon nanotubes.

Further, the first hard coat layer 16A and the second hard coat layer 16B correspond to the hard coat layer included in the conductive film of the present invention and this embodiment is as described above.

Further, a region in which the first detection electrode 30 and the second detection electrode 34 are present constitute an input region E1 (input region (sensing unit) capable of sensing contact of an object) which is capable of performing an input operation by an operator, and the, first lead-out wiring 32, the second lead-out wiring 36, and the flexible printed wiring board 38 are disposed on an outer region. Eₒ positioned outside of the input region E1.

The first detection electrode 30 and the second detection electrode 34 are sensing electrodes sensing a change in capacitance and constitute a sensing unit. That is, when a fingertip touches the touch panel, mutual capacitance between the first detection electrode 30 and the second detection electrode 34 is changed and the position of the fingertip is calculated by an IC circuit based on the amount of change.

The first detection electrode 30 play a role of detecting an input position in an X direction of a finger of the operator having approached the input region E1 and has a function of generating capacitance between the finger and the detection electrode. The first detection electrode 30 is an electrode which extends in a first direction (X direction) and is aligned in a second direction (Y direction) perpendicular to the first direction at a predetermined interval.

The second detection electrode 34 play a role of detecting an input position in a Y direction of a finger of the operator having approached the input region EI and has a function of generating capacitance between the finger and the detection electrode. The second detection electrode 34 is an electrode which extends in the second direction (Y direction) and is aligned in the first direction (X direction) at a predetermined interval. FIG. 2 describes five first detection electrodes 30 and five second detection electrodes 34, but the number thereof is riot particularly limited as long as those are provided in plural.

The first lead-out wiring 32 and the second lead-out wiring 36 are members that play a role of respectively applying a voltage to the first detection electrode 30 and the second detection electrode 34.

The first lead-out wiring 32 is disposed on the support 20 in the outer region Eₒ. One end thereof is electrically connected to the corresponding first detection electrode 30 and the other end is electrically connected to the flexible printed wiring board 38.

The second lead-out wiring 36 is disposed on the support 20 in the outer region Eₒ. One end thereof is electrically connected to the corresponding second detection electrode 34 and the other end is electrically connected to the flexible printed wiring board 38.

Moreover, FIG. 2 describes five first lead-out wirings 32 and five second lead-out wirings 36, but the number thereof is not particularly limited and, typically, a plurality of lead-out wirings are disposed according to the number of detection electrodes,

The flexible printed wiring board 38 is a plate funned by plural wirings and terminals being provided on a substrate, is connected to respective other ends of the first lead-out wiring 32 and respective other ends of the second lead-out wiring 36, and plays a role of connecting the conductive film 26 to an external device (for example, a display device).

The protective substrate 12 is a substrate disposed on the upper pressure sensitive adhesive layer 14 and plays a role of protecting the conductive film 26 or the display device 24 described below from the external environment, and the main surface thereof constitutes a touch surface. As the protective substrate, a transparent substrate is preferable and a plastic plate (plastic film) or a glass plate is used. It is desirable that the thickness of the substrate is appropriately selected depending on the respective applications.

Further, as the protective substrate 12, a polarizing plate or a circularly polarizing plate may he used and a combination of plural substrates (for example, a glass plate and a polarizing plate) may be used.

The display device 24 is a device having a display surface that displays an image and each member (for example, the lower pressure sensitive adhesive layer 22) is disposed on the display screen side. Further, a display device includes various members (for example, a polarizing plate, a color filter, a liquid crystal cell, a TFT Backplane, a backlight, and the like) constituting the device.

The type of display device 24 is not particularly limited, and a known display device can be used. Examples of the known display device include a cathode ray tube (CRT) display device, a liquid crystal display (LCD), an organic light emitting diode (OLED) display device, a vacuum fluorescent display (VFD), a plasma display panel (PDP), a surface-conduction electron-emitter display (SED), a field emission display (FED), and an E-Paper.

The upper pressure sensitive adhesive layer 14 and the lower pressure sensitive adhesive layer 22 are layers connecting each member, and known pressure sensitive adhesive layers can be used.

### Second Embodiment

Hereinafter, a second embodiment of a display device provided with a touch panel to which the conductive film of the present invention is applied will be described with reference to FIG. 4.

As illustrated in FIG. 4, a display device 110 provided with a touch panel of the present invention includes a protective substrate 12, an upper pressure sensitive adhesive layer 14, a first hard coat layer 16A, a third conductive layer 18C for a touch panel, a support 20, a lower pressure sensitive adhesive layer 22, and a display device 24 in this order. The first hard coat layer 16A, the third conductive layer 18C for a touch panel, and the support 20 constitute a conductive film 126. Further, the protective substrate 12, the upper pressure sensitive adhesive layer 14, the conductive film 126, and the lower pressure sensitive adhesive layer 22 constitute a capacitance touch panel 128. As described below, as the third conductive layer 18C for a touch panel, the above-described conductive layer containing fullerene functionalized carbon nanotubes may be exemplified. That is, the conductive film 126 corresponds to the conductive film of the present invention.

The display device 110 provided with a touch panel illustrated in FIG. 4 has the same configurations as those of the display device 10 provided with a touch panel illustrated in FIG. 1 except for the third conductive layer 18C for a touch panel. Therefore, the same constituent elements are denoted by the same reference numerals and the description thereof will not he repeated. Hereinafter, the third conductive layer 18C for a touch panel will be mainly described in detail.

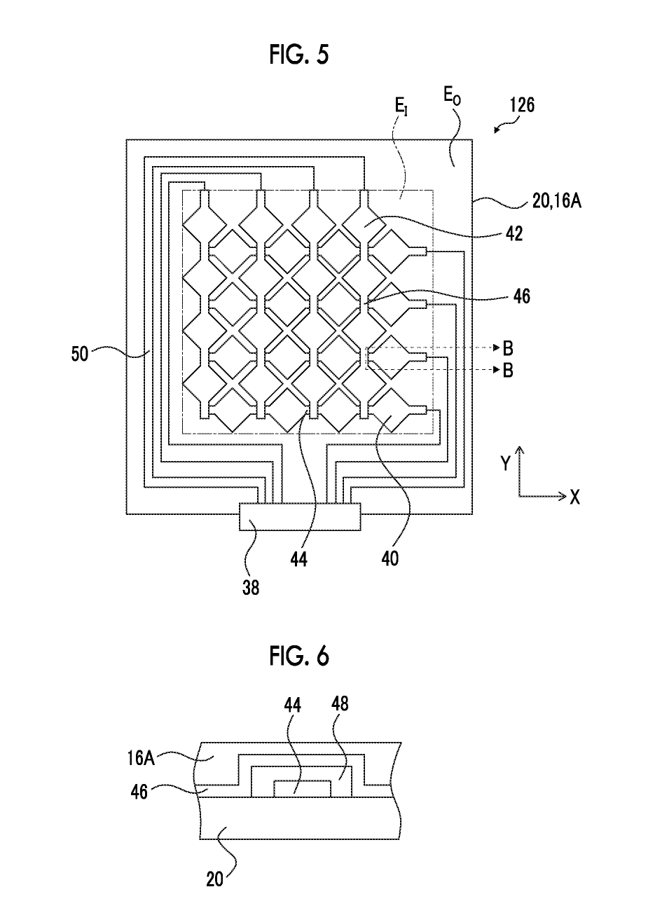

FIG. 5 is a plan view illustrating the conductive film 126. FIG. 6 is a sectional view taken along the line B-B of FIG. 5.

The conductive film 126 includes the support 20, the third conductive layer 18C for a touch panel disposed on the support 20, the first hard coat layer 16A disposed on the third conductive layer 18C for a touch panel, and a flexible printed wiring board 38 and functions as a touch panel sensor. The third conductive layer 18C for a touch panel includes a first electrode 40, a second electrode 42, a first connecting portion 44, a second connecting portion 46, an insulating layer 48, and a lead-out wiring 50.

The first electrode 40, the second electrode 42, and the lead-out wiring 50 contain fullerene functionalized carbon nanotubes. That is, the first electrode 40, the second electrode 42, and the lead-out wiring 50 correspond to the above-described conductive; layer. Further, the present invention is not limited to this embodiment, and the third conductive layer 18C for a touch panel may have the above-described conductive layer containing fullerene functionalized carbon nanotubes and the first connecting portion 44 and the second connecting portion 46 other than the first electrode 40, the second electrode 42, and the lead-out wiring 50 may contain fullerene functionalized carbon nanotubes.

Hereinafter, each member included in the third conductive layer 18C for a touch panel will be described in detail.

More specifically, a plurality (four in FIG. 5) of first electrodes 40 are linearly arranged in an x direction (horizontal direction in FIG. 5) and each of the electrodes is connected to the first connecting portion 44 to form a first electrode array. In addition, a plurality (four arrays in FIG. 5) of the first electrode arrays are arranged in parallel with each other on the support 20. The first electrode arrays correspond to so-called detection electrodes.

Further, a plurality (four in FIG. 5) of second electrodes 42 are linearly arranged in a y direction (machine direction in FIG. 5) perpendicular to the x direction and each of the electrodes is connected to the second connecting portion 46 to form a second electrode array. In addition, a plurality (four arrays in FIG. 5) of the second electrode arrays are arranged in parallel with each other on the support 20. The second electrode arrays correspond to so-called detection electrodes,

In addition, since the first electrode array and the second electrode array are arranged by intersecting with each other such that the first connecting portion 44 and the second connecting portion 46 overlap each other, the first electrodes 40 and the second electrodes 42 are arranged in a lattice form on the support 20.

Moreover, since the first connecting portion 44 and the second connecting portion 46 overlap each other, an insulating layer 48 is interposed between the first connecting portion 44 and the second connecting portion 46 in order to prevent conduction of the second connecting portion 46 perpendicular to the first connecting portion 44 for insulation.

Moreover, since the lead-out wiring 50 connected to each of the first electrode array and the second electrode array is disposed on the support 20 so that the first electrode 40, the second electrode 42, and the flexible printed wiring hoard 38 are connected to each other through the lead-out wiring 50.

In addition, a region in which the first electrode 40 and the second electrode 42 are present constitute an input region EI (input region (sensing unit) capable of sensing contact of an object) which is capable of performing an input operation by an operator, and the lead-out wiring 50 and the flexible printed wiring board 38 are disposed on an outer region Eₒ positioned outside of the input region EI.

The embodiments of the conductive film included in the display device provided with a touch panel are not limited to those described above, and other embodiments may be present.

For example, a laminated conductive film obtained by preparing two conductive films provided with a single-sided conductive layer, each of which includes the support 20, the first conductive layer 18A for a touch panel disposed on one main surface (front surface) of the support 20, and the first hard coat layer 16A described in the first embodiment described above and bonding the two conductive films provided with a single-sided conductive layer to a pressure sensitive adhesive layer such that the first conductive layers 18A for a touch panel face each other at a position where the first detection electrodes 30 in the first conductive layer 18A for a touch panel are orthogonal to each other is suitably applied to a touch panel.

Further, when the two conductive films provided with a single-sided conductive layer are bonded to each other, the two conductive films provided with a single-sided conductive layer may be bonded to a pressure sensitive adhesive layer such that the first conductive layer 18A for a touch panel of one conductive film provided with a single-sided conductive layer face the support 20 of the other conductive film provided with a single-sided conductive layer.

### EXAMPLES

Hereinafter, the present invention will be described in more detail with reference to examples, but the present invention is not limited thereto.

### Example 1

(Synthesis of Fullerene Functionalized Carbon Nanotubes (CBFFCNT))

CBFFCNT was synthesized from carbon monoxide as a carbon source using perrocene as a catalyst particle source and water vapor and/or carbon dioxide as a reagent (one or plural kinds). Hereinafter, the conditions are described in detail.

Carbon source: CO. Catalyst particle source: ferrocene (partial pressure of vapor in reactor: 0.7 Pa). Use oven temperature: 800° C., 1000° C., and 1150° C. Use flow rate: internal flow (including ferrocene vapor) of CO at 300 ccm and external flow of CO at 100 ccm. Reagent: water vapor (150 and 270 ppm) and/or carbon dioxide (1500 to 12000 ppm).

The synthesis was performed in the manner described in FIG. 3A of JP2009-515804A. In this embodiment, catalyst particles were instantly grown by ferrocene vapor decomposition. The precursor was evaporated by passing CO at room temperature through a cartridge (4) filled with ferrocene powder from a gas cylinder (2) (at a flow rate of 300 ccm). Thereafter, the flow containing ferrocene vapor was introduced to a high-temperature zone of a ceramic tube reactor through a water-cooled probe (5) and then mixed with the additional CO flow (1) at a flow rate of 100 ccm.

Subsequently, an oxidizing etchant (for example, water and/or carbon dioxide) was introduced thereto together with a carbon source. In addition, the partial pressure of ferrocene vapor in the reactor was maintained to 0.7 Pa. Thereafter, the set temperature of the reactor wall was changed from 800° C. to 1150° C.

Aerosol products were recovered at the downstream of the reactor by any of a silver disc filter or a grid of a transmission electron microscope (TEM). It was confirmed that CBFFCNT in which carbon nanotubes and fullerenes were covalently bonded to each other was present in these aerosol products.

A conductive layer containing CBFFCNT was prepared on a filter by filtering the obtained aerosols using a filter of nitrocellulose having a diameter of 2.45 cm. In addition, the temperature of the filter surface at the time of filtration was 45° C.

Next, the conductive layer disposed on the filter was transferred to a support (commercially available cellulose acylate film TD60UL (manufactured by Fujifilm Corporation), thickness: 60 μm) so that the conductive layer (thickness: 9 ₗam) was disposed on the support

Subsequently, a hard coat layer (thickness: 6 μm) was prepared on the obtained conductive layer according to the method described below, thereby obtaining a conductive film.

(Procedures for Preparing Hard Coat Layer)

4 parts by mass of IRGACURE 184 (photopolymerization initiator, manufactured by BASF Japan Ltd.) was added to a mixed solvent of methyl ethyl ketone (MEK) and methyl isobutyl ketone (MIBK) and dissolved therein while the solution was stirred, thereby preparing a solution having 40% by mass of a final solid content. Pentaerythritol triacrylate (PETA), U-4HA (tetrafunctional urethane oligomer, weight-average molecular weight of 600, manufactured by Shin-Nakamura Chemical Co., Ltd.), U-15HA (15 functional urethane oligomer, weight-average molecular weight of 2300, manufactured by Shin-Nakamura Chemical Co., Ltd.), and a polymer (7975-D41, acrylic double bond equivalent of 250, weight-average molecular weight of 15000, manufactured by Hitachi Chemical Co., Ltd.) were added, as resin components, to the solution at a solid content ratio of 25 parts by mass:25 parts by mass:40 parts by mass:10 parts by mass and the solution was stirred. A leveling agent (trade name: MEGAFACE F-477, manufactured by DIC Corporation) was added to the solution at a solid content ratio of 0.2 parts by mass and the solution was stirred, thereby preparing a composition for forming a hard coat layer.

The conductive layer was coated with the composition for forming a hard coat layer according to slit reverse coating to form a coated film. The obtained coated film was dried at 70° C. for 1 minute, irradiated with ultraviolet rays at an ultraviolet irridiation dose of 150 mJ/cm², and cured, thereby forming a hard coat layer having a thickness of 6 μm.

### Examples 2 to 11 and Comparative Example 2

Conductive films were obtained in the same manner as in Example 1 except that the type of support used in Example 1 was changed.

### Comparative Example 1

A conductive film was obtained in the same manner as in Example 1 except that a PET substrate (COSMO SHINE, manufactured by TOYOBO CO., LTD.) was used as a support and an ITO layer was prepared instead of a conductive layer including CBFFCNT the following manner.

(Preparation of ITO Layer)

A plasma treatment at an Ar flow rate of 300 sccm, an output of 700 V/0.05 A was performed on a PET substrate (COSMO SHINE, manufactured by TOYOBO CO., LTD.), the substrate was disposed in a sputtering device, a roller was heated at 140° C. while evacuation was performed, the pressure was held at 2×10⁻¹ Pa, and a transparent conductive layer formed of ITO was laminated on the surface subjected to the plasma treatment of the PET substrate with an angstrom having a thickness of 200 by performing sputtering using an oxide mixture, in which the mixing ratio of In₂O₃/SnO₃ was 90/10, as a target in the inflow of argon gas or oxygen gas, thereby obtaining a conductive layer.

### Comparative Example 3

A conductive film was obtained in the same manner as in Example 1 except that a T25UL (cellulose acylate film, manufactured by Fujifilm Corporation, film thickness of 25 μm) was used as a support and a conductive layer including CBFFCNT was not prepared.

The following evaluation was performed using conductive films of the examples and the comparative examples obtained in the above-described manner. Further, the obtained results are collectively listed in Table 1.

Flatness Evaluation

The prepared conductive films (Examples 1 to 11 and Comparative Example 3) were set on a smooth desk by placing a hard coat layer upward (air side). White light was applied from the above to observe the film surfaces according to a reflection method and the presence of wrinkles was visually determined. A case where wrinkles were not present and the flatness was excellent was evaluated as “A” and a ease where wrinkles were observed and the flatness was inferior was evaluated as “B”.

Measurement of Light Transmittance (Measurement of Total Light Transmittance)

The light transmittance was measured using a haze meter (NDH2000, manufactured by NIPPON DENSHOKU INDUSTRIES Co., Ltd.).

<Measurement of Sheet Resistance Value>

Samples having a size of 80 mm×50 mm were cut out from the prepared conductive films (Examples 1 to 11 and Comparative Examples 1 and 2) and the sheet resistance values were measured using Loresta-GP (MCP-T600) (Mitsubishi Chemical Holdings Corporation) in conformity with JIS K 7194 according to a four probe method.

In Table 1, “CNB” indicates that a conductive layer was prepared using fullerene functionalized carbon nanotubes and “ITO” indicates that a conductive layer was prepared using indium tin oxide.

TABLE 1

| | Conductive film | | | | | | | | |
|---|---|---|---|---|---|---|---|---|---|
| | Support | | | | Conductive layer | | Evaluation results | | |
| | | Re(550) | Rth(550) | Thickness | | Thickness | Light | | Sheet resistance |
| | Type | (nm) | (nm) | (μm) | Type | (μm) | transmittance | Flatness | value (Ω/□) |
| Example 1 | TD60 | 2 | 40 | 60 | CNB | 9 | 90.2% | A | 110 |
| Example 2 | TD40 | 4 | 35 | 40 | CNB | 9 | 90.5% | A | 120 |
| Example 3 | T25 | 0 | 20 | 25 | CNB | 7 | 91.1% | A | 95 |
| Example 4 | TG40 | 1 | 35 | 40 | CNB | 7 | 90.7% | A | 90 |
| Example 5 | TJ25 | 0 | 12 | 25 | CNB | 8 | 90.9% | A | 100 |
| Example 6 | ZRD40 | 1 | −3 | 40 | CNB | 9 | 90.3% | A | 120 |
| Example 7 | Sample A | 1 | 28 | 40 | CNB | 6 | 90.4% | A | 80 |
| Example 8 | Sample C | 1 | 5 | 40 | CNB | 7 | 90.8% | A | 90 |
| Example 9 | Acryl | 0 | 3 | 30 | CNB | 8 | 90.1% | A | 85 |
| Example 10 | Cycloolefine | 0 | 5 | 40 | CNB | 7 | 90.2% | A | 90 |
| Example 11 | Sample B | 0.5 | 12 | 15 | CNB | 9 | 90.1% | A | 110 |
| Comparative | PET | 1610 | 8450 | 50 | ITO | 9 | 85.2% | — | 130 |
| Example 1 | | | | | | | | | |
| Comparative | PET | 1610 | 8450 | 50 | CNB | 8 | 85.9% | — | 110 |
| Example 2 | | | | | | | | | |
| Comparative | T25 | 0 | 20 | 25 | — | 7 | 93.4% | B | — |
| Example 3 | | | | | | | | | |

The types of supports represented by symbols in the columns of “support” in Table 1 are as follows.
TD60: cellulose acylate TD60UL (manufactured by Fujifilm Corporation)
TD40: cellulose acylate film (FUJITAC TD40UC, manufactured by Fujifilm Corporation)
T25: cellulose acylate film (T25UL, manufactured by Fujifilm Corporation)

TG40: cellulose acylate film (FUJITAC TG40UL, manufactured by Fujifilm Corporation)
TJ25: cellulose acylate film (FUJITAC TJ25UL, manufactured by Fujifilm Corporation)
ZRD40: cellulose acylate film (FUJITAC ZRD40, manufactured by Fujifilm Corporation)
Acryl: acrylic film (Technolloy S001G; manufactured by Sumitomo Chemical Company Ltd.)
Cycloolefine: cycloolefine film (ZF14, manufactured by Zeon Corporation)
PET: polyethylene terephthalate film (COSMO SHINE, manufactured by TOYOBO CO., LTD.)

(Method of Preparing Sample A)

(Preparation of Core Layer Cellulose Acylate Dope)

The following composition was put into a mixing tank and stirred and each component was dissolved therein, thereby preparing a cellulose acetate solution.

| | | |
|---|---|---|
| Cellulose acetate having an acetyl | 100 | parts by mass |
| substitution degree of 2.88 | | |
| Ester oligomer A | 10 | parts by mass |
| The following additive B | 4 | parts by mass |
| Ultraviolet absorbing agent C | 2 | parts by mass |
| Methylene chloride C (first solvent) | 430 | parts by mass |
| Methanol (second solvent) | 64 | parts by mass |

(Ester oligomer A)

A copolymer (terminal is formed of an acetyl group) of an aromatic dicarboxylic acid (ratio of adipic acid:phthalic acid is 3:7) and a diol (ethylene glycol). Molecular weight of 1000

(Additive B)

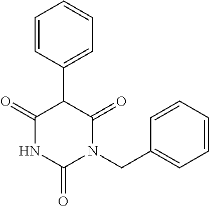 [SMILES: O=C1NC(=O)N(Cc2ccccc2)C(=O)C1c1ccccc1]

(Ultraviolet Absorbing Agent C)

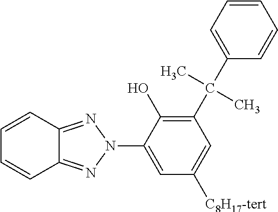

(Preparation (Outer Layer Cellulose Acylate Dope)

An outer layer cellulose acetate solution was prepared by adding 10 parts by mass of the following matting agent solution to 90 parts by mass of the above-described core layer cellulose acylate dope.

| | | |
|---|---|---|
| Silica particles having average particle size | 2 | parts by mass |
| of 20 nm (AEROSIL R972, manufactured by | | |
| Nippon Aerosil Co., Ltd.) | | |
| Methylene chloride (first solvent) | 76 | parts by mass |
| Methanol (second solvent) | 11 | parts by mass |
| Core layer cellulose acylate dope | 1 | part by mass |

(Preparation of Cellulose Acylate Film)

The core layer cellulose acylate dope and outer layer cellulose acylate dopes on both side of the core layer cellulose acylate dope, that are, three layers were cast on a drum at 20° C. from a casting port at the same time. The outer layers were peeled off in a state in which the solvent content was 20% by mass, both ends of the film in the width direction were fixed with tenter clips, and the film was dried while being stretched to 1.1 times in the transverse direction in a state in which the residual solvent was in a range of 3% to 15%. Thereafter, the film was further dried by being conveyed between rolls of a heat treatment device, thereby preparing a cellulose acylate film (sample A) having a thickness of 40 μm.

(Sample B)

A sample B was prepared in the same manner as the film formation of the sample A except that the film thickness was adjusted to 15 μm,

(Sample C)

Film preparation was carried out using the following materials.

Pellet-like ARTON (Tg of 120° C., manufactured by JSR Corporation) 20 parts by mass

Additive 1 (SUMILIZER GP (manufactured by Sumitomo Chemical Company Ltd.)) 0.1% by mass

Matting agent 1 (silicon dioxide fine particles (particle size of 20 nm)) 0.02% by mass

Further, the above-described “% by mass” indicates the proportion (% by mass) of the additive 1 (or the matting agent 1) with respect to the total mass of ARTON.

(Preparation of Film)

A molten resin which was melt at 260° C. using a kneading extruder and extruded from a gear pump was filtered using a leaf disc filter having a filtration accuracy of 5 μm. Next, the molten resin was extruded on a cast roll (CR) whose temperature was set to the glass transition temperature Tg from a hanger coat die at 260° C. with a slit interval of 1.0 mm and then a touch roll in a crown shape was brought into contact with the molten resin. Further, as the touch roll, a roll (which was referred to as a double pressing roll) described in Example 1 of JP1999-235747A (JP-H11-235747A) was used and the temperature was adjusted to Tg−5° C. (in this case, the thickness of thin metal outer cylinder was set to 3 mm). Thereafter, the molten resin was allowed to continuously pass through cast rolls whose temperatures were respectively adjusted to Tg+5° C. and Tg−10° C.

Subsequently, the molten resin was stretched in the conveyance direction at a stretching zone having a pair of nip rollers and then thermally relaxed at Tg+40° C., and the both ends (respectively 5% of the total width) were trimmed, thereby obtaining a film having a thickness of 40 μm. Further, the retardation was controlled by adjusting the stretching temperature.

As listed in Table 1, the conductive film of the present invention had excellent flatness and light transmittance.

Meanwhile, the light transmittance of Comparative Examples 1 and 2, m which a predetermined support was not used, was inferior and the flatness in Comparative Example 3 in which a predetermined conductive layer was not used, was inferior.

### Example 12

### Preparation of Touch Panel

Conductive layers were disposed on both surfaces of a support according to the procedures of Example 1. Next, by following procedures described below, as illustrated in FIG. 2, conductive layers in other portions were removed through etching by leaving only the conductive layers positioned in portions of the first detection electrodes, the first lead-out wirings, the second detection wirings, and the second lead-out wirings. Subsequently, hard coat layers were respectively disposed on patterned conductive layers in the same manner as in Example 1, thereby obtaining a conductive film.

Further, the length of the first detection electrode was 170 mm and the number of the first detection electrodes was 32. The length of the second detection electrode was 300 mm and the number of the second detection electrodes was 56.

Next, the obtained conductive film, a protective substrate, an upper pressure sensitive adhesive layer, a conductive film, a lower pressure sensitive adhesive layer, and a liquid crystal display device were laminated in order of lamination illustrated in FIG. 1, thereby obtaining a display device provided with a touch panel.

(Method of Etching Conductive Layer)

A desired pattern was formed on a conductive layer disposed on a support according to a laser etching method (for example, see WO2013/176155A) using a UV laser.

In the description above, the conductive layer was disposed on the support and subjected to an etching treatment, and then a hard coat layer was disposed on the patterned conductive layer. Alternatively, after a conductive layer and a hard coat aver were disposed on a support, a conductive layer with a predetermined pattern was prepared according to the above-described etching method, and then a display device provided with a touch panel was prepared in the above-described manner.

In addition, a display device provided with a touch panel illustrated in FIG. 4 was obtained in the same manner as described above except that a conductive layer was disposed on one surface of the support and the etching pattern of the conductive layer was changed into a pattern shown in the third conductive layer 18C for a touch panel illustrated in FIG. 5.

### EXPLANATION OF REFERENCES

10, 110: display device provided with touch panel

12: protective substrate

14: upper pressure sensitive adhesive layer

16A, 16B: hard coat layer

18A, 18B, 18C: conductive layer for touch panel

20: support

22: lower pressure sensitive adhesive layer

24: display device

26, 126: conductive film

28, 128: touch panel

30: first detection electrode

32: first lead-out wiring

34: second detection electrode

36: second lead-out wiring

38: flexible printed wiring hoard

40: first electrode

42: second electrode

44: first connecting portion

46: second connecting portion

48: insulating layer

50: lead-out wiring

What is claimed is:

1. A conductive film comprising:
a support which has an in-plane retardation of 10 nm or less at a wavelength of 550 nm and has a retardation of −60 to 60 nm at a wavelength of 550 nm in a thickness direction;
a conductive layer which is disposed on at least one surface of the support, includes fullerene functionalized carbon nanotubes, and has a thickness of less than 10 μm; and
a hard coat layer which is disposed adjacent to the conductive layer.

2. The conductive film according to claim 1,
wherein a sheet resistance value is in a range of 10 to 150 Ω/□.

3. The conductive film according to claim 1,
wherein the thickness of the support is in a range of 10 to 80 μm.

4. The inductive film according to claim 2,
wherein the thickness of the support is in a range of 10 to 80 μm.

5. The conductive film according to claim 1,
wherein the support includes at least one selected from the group consisting of a cellulose acylate resin, an acrylic resin, a methacrylic resin, and a cycloolefine resin.

6. The conductive film according to claim 2,
wherein the support includes at least one selected from the group consisting of a cellulose acylate resin, an acrylic resin, a methacrylic resin, and a cycloolefine resin.

7. The conductive film according to claim 3,
wherein the support includes at least one selected from the group consisting of a cellulose acylate resin, an acrylic resin, a methacrylic resin, and a cycloolefine resin.

8. The conductive film according to claim 4,
wherein the support includes at least one selected from the group consisting of a cellulose acylate resin, an acrylic resin, a methacrylic resin, and a cycloolefine resin.

9. A polarizing plate comprising:
the conductive film according to claim 1; and
a polarizer.

10. A polarizing plate comprising:
the conductive film according to claim 2; and
a polarizer.

11. A polarizing plate comprising:
the conductive film according to claim 3; and
a polarizer.

12. A polarizing plate comprising:
the conductive film according to claim 5; and
a polarizer.

13. The conductive film according to claim 1, which is used for a touch panel.

14. The conductive film according to claim 2, which is used for a touch panel.

15. The conductive film according to claim 3, which is used for a touch panel.

16. The conductive film according to claim 5, which is used for a touch panel.

17. A display device provided with a touch panel comprising:
the conductive film according to claim 13.

18. A display device provided with a touch panel comprising:
the conductive film according to claim 14.

19. A display device provided with a touch panel comprising:
the conductive film according to claim 15.

20. A display device provided with a touch panel comprising:
the conductive film according to claim 16.
